(19) United States
(12) Patent Application Publication
(10) Pub. No.: US 2014/0045472 A1
(43) Pub. Date: Feb. 13, 2014

(54) PROVISIONING-FREE MEMBERLESS GROUP COMMUNICATION SESSIONS

(71) Applicant: QUALCOMM Incorporated, San Diego, CA (US)

(72) Inventors: Sandeep Sharma, San Diego, CA (US); Mohammed Ataur Rahman Shuman, San Diego, CA (US); Vijay A. Suryavanshi, San Diego, CA (US); Mark A. Maggenti, Dal Mar, CA (US)

(73) Assignee: QUALCOMM Incorporated, San Diego, CA (US)

(21) Appl. No.: 13/963,137

(22) Filed: Aug. 9, 2013

Related U.S. Application Data
(60) Provisional application No. 61/682,421, filed on Aug. 13, 2012.

(51) Int. Cl. H04W 4/08

(52) U.S. Cl. CPC H04W 4/08
USPC 455/416

(57) ABSTRACT

Systems, methods, and devices of the various embodiments enable dynamically creating and joining group communication sessions without (i.e., “free of”) operator-controlled or operator-assisted provisioning. By encoding group call provisioning information in a bar code, such as a Quick Response Code (“QR code”), that participants can scan using their mobile communication devices (e.g., smart phones), a group call may be created and provisioned on communication devices. The QR code encodes the information needed to initiate and/or join a group communication session maintained by a group communication server.

### RELATED APPLICATIONS

This application claims the benefit of priority to U.S. Provisional Patent Application No. 61/682,421 entitled “Provisioning-Free Memberless Group Communication Sessions” filed Aug. 13, 2012, the entire contents of which are hereby incorporated by reference.

### BACKGROUND

In current group communication systems, especially group calling systems, the operator of the group communication system creates the groups and provides the group communication information to the users. In current systems, groups are maintained and provisioned by the network operator, and group IDs are provided to the group members to access the group. Using the received group ID, a user may access a group management server, and upon authentication with a predefined participant list, may be granted access to the operator established group. Current systems involve the network operator provisioning the network backend components, such as databases with group membership information, followed by over-the-air (“OTA”) provisioning of group communication information to user devices, such as smart phones. In current systems, to create ad hoc groups, the originator or group owner must have prior knowledge of who will be the group members and the originator or group owner must explicitly send out group invites or call requests coordinated with the network operator because the network operator actually creates the group. The need to contact the network operator is time consuming and costly. Additionally, the static nature of current systems limits the applications for group communications.

### SUMMARY

Systems, methods, and devices of the various embodiments enable dynamically creating and joining group communication sessions without (i.e., “free of”) operator-controlled or operator-assisted provisioning. In an embodiment, by encoding group call provisioning information in a bar code, such as a Quick Response Code (“QR code”), that participants can scan using their communication devices (e.g., smart phones), a group call may be created and provisioned on communication devices.

### BRIEF DESCRIPTION OF THE DRAWINGS

The accompanying drawings, which are incorporated herein and constitute part of this specification, illustrate exemplary embodiments of the invention, and together with the general description given above and the detailed description given below, serve to explain the features of the invention.

FIG. 1 is a communication system block diagram of a network suitable for use with the various embodiments.

FIG. 2 is a diagram of an example Quick Response (“QR”) Code suitable for use with the various embodiments.

FIG. 3 is a process flow diagram illustrating an embodiment method for generating a QR code.

FIG. 4 is a process flow diagram illustrating an embodiment method for generating multiple QR codes.

FIG. 5 illustrates example operations performed by a communication device to scan a QR code according to the various embodiments.

FIG. 6 illustrates example operations performed by a group of communication devices to join a group communication.

FIG. 7A is a communications flow diagram illustrating example interactions between group communications members and a server to establish a group communication.

FIG. 7B is another communications flow diagram illustrating example interactions between group communications members and QAS/ESE server(s) to establish a group communication.

FIG. 8 illustrates additional example operations performed by another group of communication devices to join another group communication.

FIG. 9 is a process flow diagram illustrating an embodiment method for using a QR code to establish a group communication.

FIG. 10 is a process flow diagram illustrating an embodiment method for establishing a group communication.

FIG. 11 is a process flow diagram illustrating an embodiment method for generating a new QR code.

FIG. 12 is a process flow diagram illustrating another embodiment method for establishing a group communication.

FIG. 13 is a data structure diagram illustrating potential elements of a QR code.

FIG. 14 is a component diagram of an example communication device suitable for use with the various embodiments.

FIG. 15 is a component diagram of another example communication device suitable for use with the various embodiments.

FIG. 16 is a component diagram of an example server suitable for use with the various embodiments.

### DETAILED DESCRIPTION

The various embodiments will be described in detail with reference to the accompanying drawings. Wherever possible, the same reference numbers will be used throughout the drawings to refer to the same or like parts. References made to particular examples and implementations are for illustrative purposes, and are not intended to limit the scope of the invention or the claims.

The word “exemplary” is used herein to mean “serving as an example, instance, or illustration.” Any implementation described herein as “exemplary” is not necessarily to be construed as preferred or advantageous over other implementations.

As used herein, the terms “mobile device,” “mobile computing device,” “receiver device,” and “communication device” are used interchangeably herein to refer to any one or all of cellular telephones, smart phones, personal or mobile multi-media players, personal data assistants (PDA's), laptop computers, tablet computers, smart books, palm-top computers, wireless electronic mail receivers, multimedia Internet enabled cellular telephones, wireless gaming controllers, and similar personal electronic devices which include a programmable processor and memory and circuitry for participating in group communication sessions, generating a bar code (e.g., a Quick Response Code (“QR code”)), and/or reading a bar code (e.g., a QR code).

The various embodiments are described herein using the term “server.” The term “server” is used to refer to any computing device capable of functioning as a server, such as a group management server, master exchange server, web server, mail server, document server, content server, or any other type of server. A server may be a dedicated computing device or a computing device including a server module (e.g., running an application which may cause the computing device to operate as a server). A server module (e.g., server application) may be a full function server module, or a light or secondary server module (e.g., light or secondary server application) that is configured to provide synchronization services among the dynamic databases on mobile devices. A light server or secondary server may be a slimmed-down version of server type functionality that can be implemented on a mobile device thereby enabling it to function as an Internet server (e.g., a group management server) only to the extent necessary to provide the functionality described herein.

The various embodiments solve the problems with current group communication systems by providing a method for dynamically creating and joining group communication sessions without (i.e., “free of”) operator-controlled or operator-assisted provisioning. In an embodiment, by encoding group call provisioning information in a bar code, such as a Quick Response Code (“QR code”), that participants can scan using their mobile communication devices (e.g., smart phones), a group call may be created and provisioned on communication devices, eliminating the need for the network operator to be involved in the call set up and provisioning. With a QR code used to store the group provisioning information, joining a group call may be as easy as scanning/imaging the QR code, eliminating the need for call participants to interact with the network operator via an OTA provisioning transaction (as per the current system). In a further embodiment, group controls, such as Time-to-Live (“TTL”) controls, rules, and/or participant restrictions may be included in the QR codes and applied to the created group communications. This may enable the group call creator (the device that generates the QR code) to establish closed or open groups, and assign different rights and roles to certain participants via the information encoded in the QR code. In another embodiment, as additional participants are added to closed groups a new QR code for the group communication session may be created and provided to all participants (e.g., via SMS or MMS messaging), enabling a dynamic group call to be managed by a call manager without the need for network operator involvement or the use of conventional OTA provisioning. Since network involvement in group calls involves greater costs and additional hassles, dynamic self provisioning of a group communication using QR provisioning may enable wider use of the group calls and the use of group calls in new applications and circumstances.

The various embodiments provide a method for operator free dynamic, user-defined, creation, and provisioning of open and/or closed group communication sessions using QR codes to deliver the call provisioning information to participant devices. Previous group management systems, such as a the group management server described in U.S. Pat. No. 7,647,036, have provided QR codes generated by the group management server including a unique user ID, unique password, and group management URL, and given the QR codes to each user in a pre-defined group as a method for merely registering trusted devices of authorized users. In such previous systems, once the trusted devices were registered for the authorized users, QR codes were not used again, especially not in relation to group communication sessions.

In an embodiment, a call originator may define parameters for a group call (e.g., using an application) and may generate a QR code encoding the information necessary to enable call participants to join the group communication at a group management server. The call set up and generation of the QR code may be accomplished on a computing device, such as a user's smart phone. In an embodiment, a QR code may be used to encode the call provisioning information, validity/availability time, restrictions on participants, and participant rights and roles. Since the QR code may encode about 1.5 KB of information, a complete set of provisioning information may be fit into an ordinary QR code. Once the QR code is generated, it may be printed and posted and/or transmitted as an image to mobile computing devices. Since the QR code may include all of the provisioning information to join a call, the originator may set up the call and pass the information to participants without the need for operator initiated OTA provisioning and the associated provisioning infrastructure (i.e., OMA-DM, XCAP, and/or ACAP provisioning systems).

Participants may join the group call simply by scanning the QR code using a communication device QR code scanning application. The communication device may read the embedded group communication information and use that information in a PTT/PTX or other group communication application to join a group communication session with a group management server. The information that can be encoded in a QR code may enable an originator to establish the group communication for open groups with unknown and potentially unlimited participants because there is no need for prior knowledge of the group members when defining the group. This lack of a need for prior knowledge distinguishes current systems because current systems need prior knowledge of the group members to enable OTA provisioning by the network operator. In an embodiment, additional information in the QR code, such as rules, security hashes, and/or algorithms, as well as the QR code's inherent non-human discernable information characteristics, may easily enable public sharing of group characteristics while preserving closed group like restrictions on group membership.

In an embodiment, an originator may use an application on their communication device to set up the parameters for a new group communication session and generate a QR code that encodes the associated provisioning information for joining the group communication session. The generated QR code may embed the necessary call establishment (i.e., provisioning) information, such as a group name, group identifier, telephone numbers, and originator information. Additionally the QR code may encode validity times/dates (i.e., the day and time that the call may be established), TTL controls, geofencing controls (e.g., boundaries within which the group call may be initiated), member identifiers, member ranks and roles, connection information (e.g., a hidden service set identifier (“SSID”) of a Wi-Fi® network to be used for a group communication), billing information (e.g., billing/cost information associated with joining the group and/or billing/cost information related to member ranks and roles), and group joining restrictions. The generated QR code may be printed and/or displayed for scanning by other users. As examples, the QR code may be displayed on the originating device, in messages sent to other devices, on print media, on fliers, on local display devices, etc.

In an embodiment, users who want to join the group may scan the QR code using their communication devices running a QR scanner application. A PPT/PTX application on the joining user's communication device may retrieve the information embedded in the QR code, and use the group definition information to communicate with the group call management server as part of a join request message. In an embodiment, upon receiving at least a portion of the information in the QR code from a communication device, the group call management server may create the group for the first participant to join, or add the participant to an on-going call and update the membership information to reflect current participants. The group call may then proceed as if it had been established through the network operator, including transmitting call data to all participants, controlling the floor or otherwise mediating the communications, and enabling participants to leave the call.

In an example embodiment, a celebrity may create an open group on their mobile device and generate a QR code embedding information defining the open group. In an embodiment the celebrity may also embed information in the QR code that specifies group controls, such as limiting all users, except the celebrity, to a listen-only mode. The celebrity may post the generated QR code to a social networking portal, such as Facebook® or may provide the QR code with print media, such as a movie poster, magazine advertisement, business card, etc. In an embodiment, the celebrity may join the group, which may create the group at one or more servers, such as a QChat Application Server (“QAS”) and/or an External Server Enabler (“ESE”). QAS is a QChat implementation of a group communication server, and ESE, which is a QChat product, enables the end user using QAS to communication with an external service, such as Facebook®, Twitter®, a webpage, a blog, etc. The group may have no members when first created, and as such may be created as a member-less group at the server. At some point a first user may scan the QR code to load the group communication information onto the first user's mobile device. The first user's mobile device may contact the server with a join request message and the server may update the member list to include the first user. In a similar manner, the second user may also scan the QR code, which may provision the group communication information to the second user's mobile device. The second user's mobile device may also contact the server and the server may update the member list to include the second user.

In an embodiment, rather than a member-less group being created by the originator when the QR code is generated, no group may be created until the first user scans the QR code and sends a join request message to the server. In this manner, the group call may not be created until embedded information from a QR code is received at the server. Instead, the QR code may embed all of the information that the server needs to receive from the first communication device to establish and launch the group call.

In an embodiment, the QR code may include additional information for managing or limiting a group call, including group controls, call times/dates, geographic bounds, member identifiers, member priorities, connection information (e.g., a hidden SSID), billing information, etc. As an example, the QR code may encode a location derived from GPS coordinates and group controls limiting call participation to only those communication devices within a predefined radius (i.e., a geofence) of a location.

As another example, the QR code may include TTL controls for the group defining how long the group call will be operational and the period after which the group will be deleted, deactivated and/or unavailable.

As another example, security codes may be embedded in the QR code either as-is (i.e., hash) or in algorithmic form. Using the embedded security codes a group communication application resident on a scanning communication device may determine whether the end user is permitted to join the corresponding group.

As another example, member ranks and roles may be specified in the QR code and/or floor control modes (i.e., listen only vs. interactive). Thus, participants who scan a first QR code may have greater privileges or priorities than those who scan a second, different QR code. This enables the call originator to define and manage roles and priorities of group call participants just by controlling distribution of the different QR code images (e.g., on fliers vs. posters).

As an additional example, billing information may be embedded in the QR code. Billing information may include charging rules and/or charging codes. The billing information embedded in the QR code may include billing/costs associated with joining the group communication, such as messaging rates, connection charges, etc. The billing information embedded in the QR code may also include information related to what the QR code enables, such as a number of floor control/talk spurt attempts. In this manner, billing information may provide an indication of the costs of the communication and what a user may be paying for by using the QR code to join a group communication.

As another example, member identifiers may be embedded in the QR code. Member identifiers may be the user and/or participant IDs of members that the originator pre-assigns to the group. A communication device scanning the QR code that is not associated with a listed member identifier may not attempt to use the QR code to join the group communication session and/or a server receiving a request to join the group from a communication device not associated with a listed member identifier may prevent the communication device from joining the group communication session. In this manner, a private group with a pre-assigned set of group members may be created by the originator, and even though non-members may scan the QR code, non-members may be prevented from joining the group communication session.

As a further example, connection information may be embedded in the QR code. Connection information may be information directing the communication device scanning the QR code to use a specific connection to join the group communication session. The connection information embedded in the QR code may include a network information, such as the SSID (e.g., a hidden SSID listed in the QR code but not broadcast by routers of the network) of a specific Wi-Fi® network to use for the group communication, a Uniform Resource Locator (“URL”) of a server hosting connection set-up information for the group communication session, etc. In this manner, a communication device may scan the QR code and receive connection information enabling the communication device to join the group communication session using a connection dedicated for the group communication session.

As another example, session information may be embedded in the QR code. Session information may include the host server name for the group communication session, URL/URI of the server, vocoders to be used for the group communication session, etc.

In a further embodiment, to ensure that the information pertinent to the group is safe from misuse, despite the QR code being public, the application generating the QR code may generate an encrypted QR code that encodes an encrypted aggregation of group communication information. In this manner, only users whose computing devices are able to decrypt the QR code or the data within the QR code can obtain the group communication information.

In an embodiment, groups may be closed when generated. As an example, the QR code for a closed group may include the authorized participant list. In a further embodiment, if additional participants are added to the closed group, a new QR code including the updated authorized participant list may be generated and sent to all authorized participants, e.g., by SMS or MMS.

In an embodiment, more than one QR code may be generated by the originator, each QR code having different embedded information, such as different group controls. As an example, one QR code may enable users scanning it to be active participants both sending and receiving during the group session. Another QR code may enable users scanning it to listen only during the group session. In this manner, while users may join the group with either QR code, the QR code used to join the group may be used to manage user abilities within the group session. As another example, more than one QR code may be generated and each may have different embedded billing information, different group controls, and/or be associated with a different level of Quality of Service (“QoS”) during the group session. One QR code, which might be advertised as a “Gold QR,” may enable communication devices scanning it to make a floor control/talk spurt attempt, have a higher talker rank, and/or ensure a higher QoS (e.g., a higher bandwidth connection to a session hosting server) during the session and may have a high cost associated with joining the group session using that QR code. Another QR code, which might be advertised as a “Silver QR,” may only enable communication devices scanning it to listen during the group session and may provide a lower QoS (e.g., a lower bandwidth connection to a session hosting server than the connection of “Gold QRs”) and may have a lower cost associated with joining the group session using that QR code. In this manner, a user may control their group session abilities, QoS, and/or costs by scanning either the “Gold QR” or the “Silver QR.”

In an embodiment, a QR code may include an attribute or information request. As an example, an attribute request may be an indication of information a joining communication device must include in any join request message sent to the group communication server. As examples, the information requested via such a QR code may include username, phone number, device ID (e.g., device name, MAC ID, etc.), location, hash code, carrier ID, etc. A communication device scanning the QR code including the attribute request may identify the required attribute information and may include the required attribute information in a generated join request message.

In an embodiment, a group communication server receiving a join request from a communication device scanning a QR code may compare user and/or device information associated with the communication device sending the join request to a list of user and/or device information (e.g., MAC ID) to control the treatment of the join request. In an embodiment, the user and/or device information may be sent with the join request in response to an attribute request embedded in the QR code. As an example, join requests may include a user ID of the current user of any communication device that scans the QR code and originates a join request. The group communication server may compare the user ID in each received join request to a list of user identifiers (e.g., employee user IDs) available to the server. A join request including a user ID matching one of the listed user identifiers (e.g., an employee user ID) may result in the communication device being joined to the group communication session at a different service level (e.g., at a higher QoS connection, with a higher member rank, etc.) than a service level (e.g., lower QoS, lower member ranked, etc.) assigned to a communication device associated with a user ID that does not match any one of the listed user identifiers (e.g., employee user ID). In this manner, join requests from recognized users/devices (e.g., known employees, users, devices, etc.) may be assigned logically different service levels from those assigned to guests (e.g., unknown users, devices, etc.).

In another embodiment, QR codes may be used to control access to one or more networks. Connection information and/or member lists may be embedded in a QR code enabling a communication device scanning the QR code to establish a connection to the network. In this manner, QR codes with different connection information may be used to enable communication devices to establish different connections to a network by scanning different QR codes.

As an example, Wi-Fi® router may support a first type of connection to a network and a second type of connection to the network. The first type of connection may be a full service connection without access restrictions, such as no data usage or bandwidth limits, no file type restrictions, etc. The first type of connection may be associated with a first SSID (e.g., a hidden SSID not broadcast by the router). The second type of connection may be a guest service connection with access restrictions, such as a pre-set maximum data usage and bandwidth limit, a file type restriction, etc. The second type of connection may be associated with a second SSID (e.g., a SSID broadcast by the router or a hidden SSID not broadcast by the router). A list of authorized users of the first type connection may be available to the router. A first QR code for the first type of full service connection may be generated, and the QR code may include connection information (e.g., the hidden SSID, security code, etc.) for the first type connection and/or the list of authorized users of the first type connection. A second QR code for the second type of guest service connection may be generated with the connection information (e.g., SSID, security code, etc.) of the second type of connection. A communication device scanning the first QR code may use the connection information and/or list of authorized users embedded in the first QR code to connect to the full service connection. A communication device scanning the second QR code may use the connection information embedded in the second QR code to connect to the guest service connection. In this manner, the setup and provisioning of different logical service level connections to a router and/or network may be simplified because the connection information may be embedded in the QR code eliminating the need to provide each element of connection information (e.g., SSID, security code, etc) to users manually.

In another example embodiment, a conference organizer may create a group communication or limited access wireless network and generate a QR code specifically for use in allowing audience members to ask audience questions at a conference via the group communication or limited access wireless network. Public network connections, such as publically broadcast Wi-Fi® connections at a conference may be resource constrained when many conference participants attempt to use the same Wi-Fi® connections at the same time. To facilitate receiving questions from the audience at the conference, the conference organizers may establish a separate Wi-Fi® network associated with a hidden SSID that may not be broadcast. The use of a hidden SSID with the separate Wi-Fi® network may limit access to the separate Wi-Fi® network to only those communication devices provided with an out of band indication of the hidden SSID. By limiting the number of communication devices that are provided with the hidden SSID the demands on the separate Wi-Fi® network may be limited. A QR code for an audience question group may be generated that encodes the hidden SSID of the separate Wi-Fi® network, and the QR code may be provided to those audience members or others wishing to ask questions at the conference. An audience member wishing to ask a question may scan the QR code and use that user's communication device may use the hidden SSID embedded in the QR code to join the group communication session using the separate Wi-Fi® network dedicated for audience questions. Audience members accessing such a network may be given the floor so they may ask their questions via their communication devices. Audience questions communicated in this manner may be played over the a group communication session for other conference members to listen to via their communication devices and/or played over a public address system of the conference. In this manner, distribution of the QR codes may be used to control both the audience members who can ask questions and the network pathway by which questions are communicated.

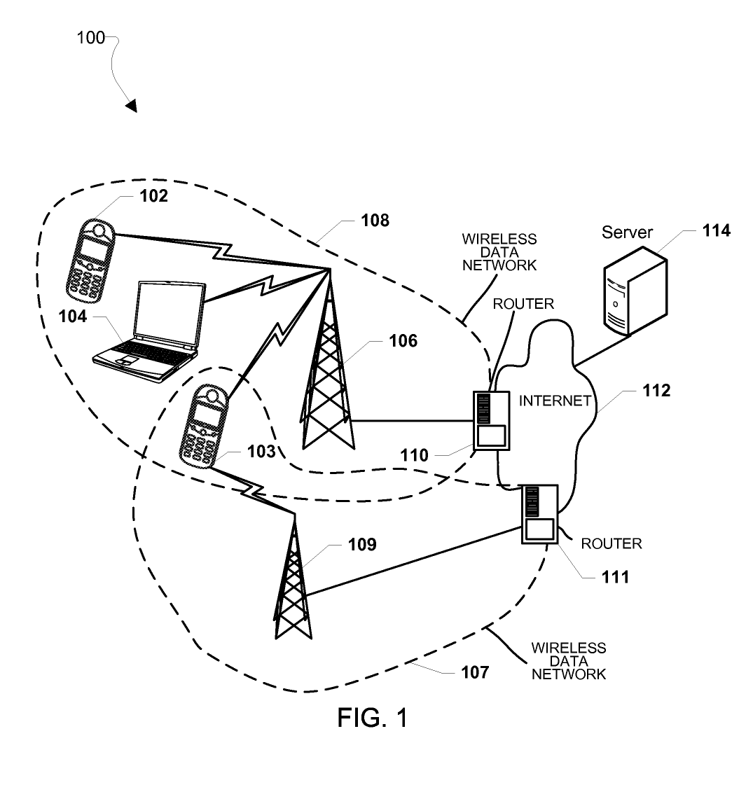

FIG. 1 illustrates a wireless network system 100 suitable for use with the various embodiments. Communication devices 102, 103, and 104 and a wireless transmitter/receiver 106 together make up a wireless data network 108. Using the wireless data network 108, data may be transmitted wirelessly between the communication devices 102, 103, and 104 and the wireless cell tower or base station 106. The transmissions between the communication devices 102, 103, and 104 and the wireless cell tower or base station 106 may be by any cellular networks, including Wi-Fi®, CDMA, TDMA, GSM, PCS, G-3, G-4, LTE, or any other type connection. The wireless network 108 may be in communication with a router 110 which connects to the Internet 112. In this manner data may be transmitted from/to the communication devices 102, 103, and 104 via the wireless network 108, and router 110 over the Internet 112 to/from a server 114 by methods well known in the art.

Additionally, one or more of the communication devices, such as communication device 103, and a wireless transmitter/receiver 109 may together make up another wireless data network 107. The wireless data network 107 may overlap partially or entirely in geographic coverage with another wireless data network 108. For example, one wireless data network 108 may be a first wireless network established in a conference venue and the other wireless data network 107 may be a second wireless network established in a conference venue. Using the second wireless data network 107, data may be transmitted wirelessly between the communication devices 103, and the wireless cell tower or base station 109. The transmissions between the communication devices 103, and the wireless cell tower or base station 109 may be by any cellular networks, including Wi-Fi®, CDMA, TDMA, GSM, PCS, G-3, G-4, LTE, or any other type connection. The wireless network 107 may be in communication with a router 111 that connects to the Internet 112. In this manner data may be transmitted from/to the communication devices, such as communication device 103, via the wireless network 107, and router 111 over the Internet 112 to/from a server 114 by methods well known in the art.

While the various embodiments are particularly useful with wireless networks, the embodiments are not limited to wireless networks and may also be implemented over wired networks with no changes to the methods.

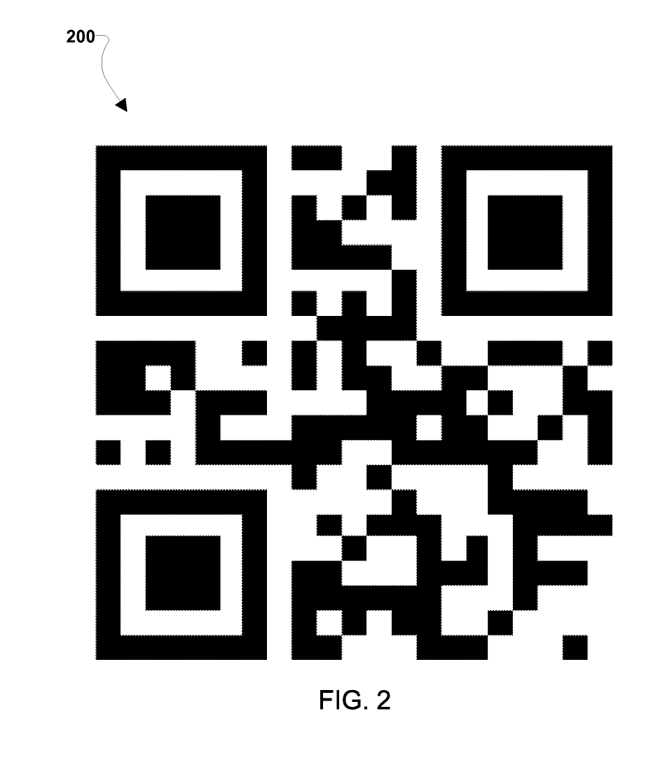

FIG. 2 illustrates a Quick Response (“QR”) Code 200 suitable for use with the various embodiments. A QR code 200 may be a two-dimensional bar code encoding information in a pattern that may be read by a bar code scanner. A bar code scanner may be any device (e.g., a smart phone) with an imaging apparatus, such as a camera, and processor configured with processor executable instructions (e.g., a group communication application enabled to use QR code 200 to provision groups) to read the QR code 200 by translating the pattern of the QR code 200 into information. In an embodiment, segments of the QR code 200 may correspond to data fields representing rules and criteria (i.e., group communication information such as group communication controls, group ID, group name, etc.) for a group communication. In an embodiment, a group communication application running on the processor of a device scanning the QR code 200 may validate and implement the rules and criteria in the QR code 200 without the need to validate the rules and criteria with a group communication provider and/or remote server. While described in terms of a specific type of bar code, a QR code 200, in the various embodiments a QR code 200 may be substituted with other linear or matrix barcodes, such as a High Capacity Color Barcode, PDF417 codes, etc.

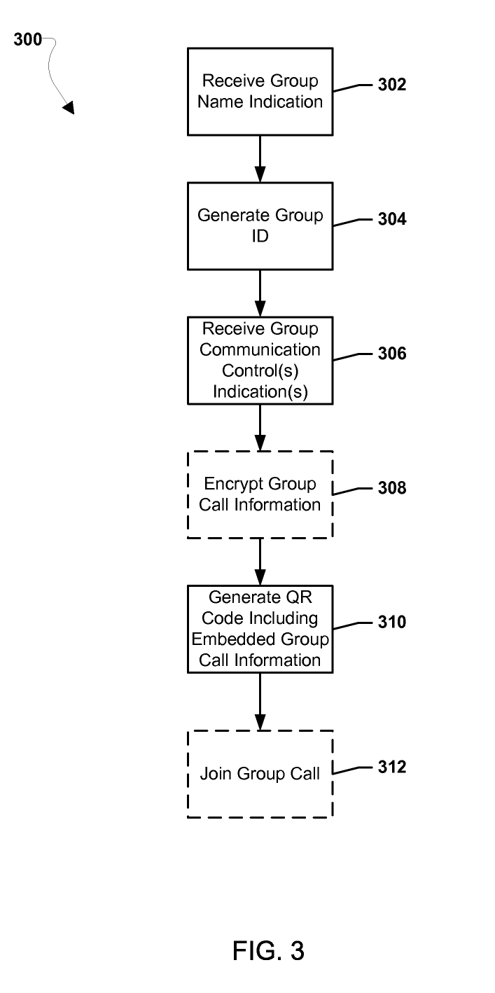

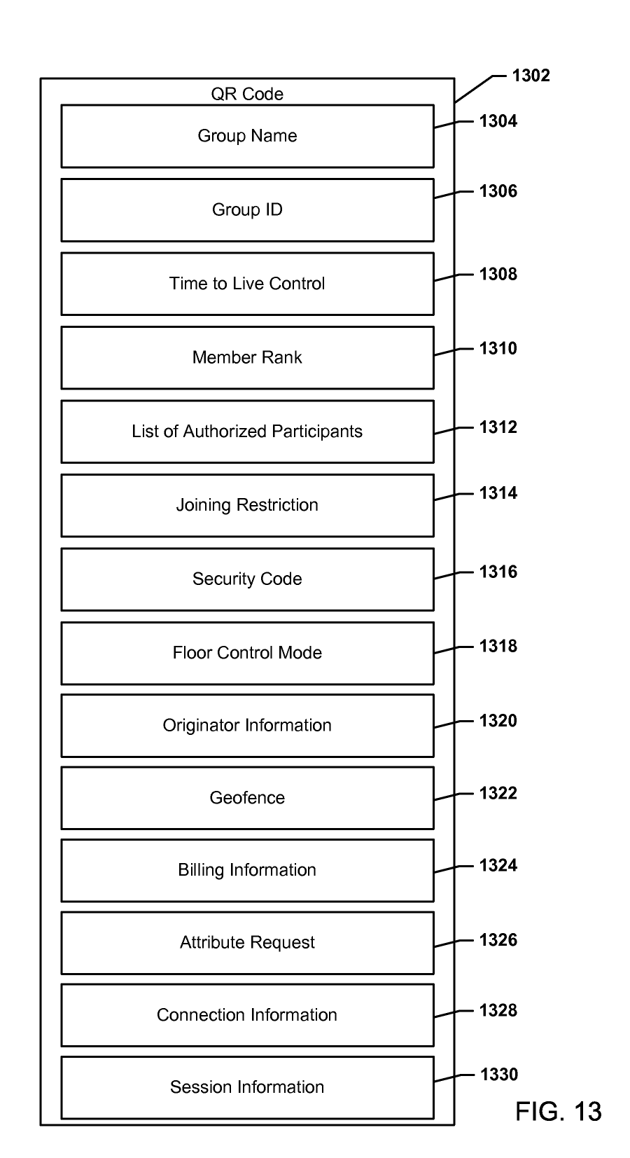

FIG. 3 illustrates an embodiment method 300 for generating a QR code. In an embodiment, the operations of method 300 may be performed by a processor of a communication device running a group communication application. In block 302 the communication device processor may receive a group name indication. In an embodiment, a group name indication may be a name the originator of a group may assign to the group communication and input to the communication device using an input/output device of the communication device, such as a keyboard or touch screen. In block 304 the communication device processor may generate a group ID. In an embodiment, a group ID may be a unique numeric identifier generated each time a new group is created. As an example, the group ID may include originator information combined with time and date information to ensure that each group ID is unique. In block 306 the communication device processor may receive group communication control(s) indication(s). In an embodiment, the originator of a group may select the group communication controls on a per group member and/or on a group wide basis. As an example, the group originator may select group communication controls from a drop down menu displayed on the communication device, such as time-to-live indications, speaker ranks, etc. Group communication controls may include one or more of a time-to-live (“TTL”) control, geofencing control, talker rank, member identifier(s), member rank(s), joining restriction, connection information, security code, floor control mode, billing information, attribute request, session information, and/or a list of authorized participants for the group communication. Group communication controls are discussed further below with reference to FIG. 13.

At optional block 308 the communication device processor may encrypt the group communication information. In an embodiment, a security hash/key may be used to encrypt the group communication information prior to generating a QR code including the group communication information and the security hash/key may be provided to selected recipients independent of a generated QR code. In this manner, though anyone with access to the QR code may scan the QR code, only those recipients with the security hash/key will be able to decrypt the information embedded in the QR code.

In block 310 the communication device processor may generate a QR code including the embedded group communication information. In an embodiment, generating a QR code including the embedded group communication information may include encoding the group communication information, such as group ID, group name, group communication controls, etc., adding error correction, masking the encoded group communication information into a QR code pattern, and displaying, printing, storing, and/or transmitting the QR code pattern of the group communication information. As examples, generating a QR code including the embedded group communication information may result in an image of QR code which may be printed on posters, flyers, cards, etc., displayed on a screen of an originator's smart phone, and/or emailed as an image file to group participants. At optional block 312 the communication device processor may join the group call. As an example, the communication device processor may send a join request message to group communication server including the information embedded in the QR code.

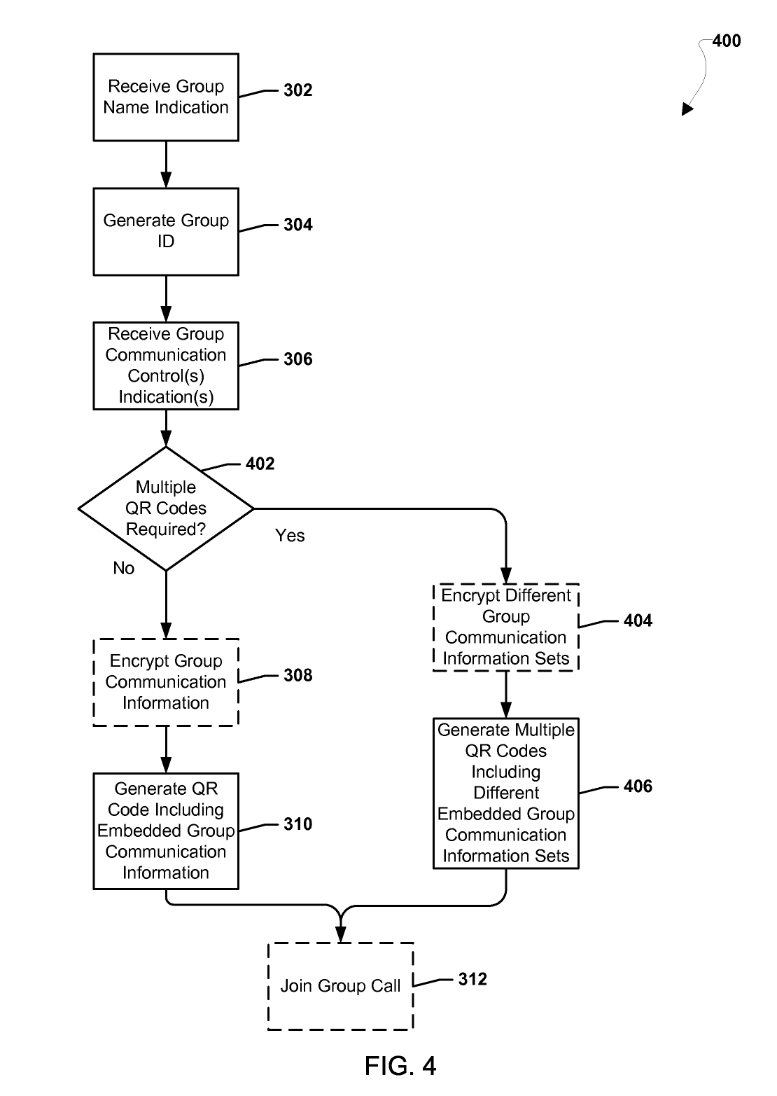

FIG. 4 illustrates an embodiment method 400 similar to method 300 described above with reference to FIG. 3, except that in method 400 multiple different QR codes with different embedded group communication information may be generated by the communication device processor. In blocks 302, 304, and 306 the communication device processor may perform the operations of like numbered blocks of method 300 described above with reference to FIG. 3. In determination block 402 the communication device processor may determine whether multiple QR codes may be required. In an embodiment, the communication device processor may determine whether multiple QR codes may be required based upon receiving an indication of a user input selecting the generation of multiple QR codes. In another embodiment, the communication device processor may determine whether multiple QR codes may be required based on the group communication controls. As an example, in an embodiment in which a group originator designates that certain participants may have speaking and listening privileges in a group communication while other participants may only listen in the group communication, the communication device processor may determine that a first QR code may be required to grant participants speaking and listening privileges and a second, different QR code, may be required to grant participants only listening privileges.

If multiple QR codes are not required (i.e., determination block 402=“No”), in blocks 308, 310, and 312 the operations of like numbered blocks of method 300 described above with reference to FIG. 3 may be performed by the communication device processor. If multiple QR codes are required (i.e., determination block 402=“Yes”), at optional block 404 the communication device processor may encrypt different group communication information sets. As an example, in an embodiment in which different group communication controls are designated, such as different speaking/listening permissions, the different group communication controls may each be encrypted with their own group communication information sets. In this manner, the different group communication information sets may enable different rules and criteria to be applied to different participants of the group communication. In block 406 the communication device processor may generate multiple QR codes including different embedded group communication information sets.

As an example, in an embodiment in which speaking and listening permissions may be different, a first QR code may be generated which grants speaking and listening permission to a participant scanning the first QR code, and a second QR code may be generated which grants only listening permission to a participant scanning the second QR code. In this manner, different QR code may be provided to different participants to control the capabilities of each participant. As an example, volunteers at an event may be given the first QR code, while members of the public attending the event may be given the second QR code. As discussed above, at optional block 312 the communication device may join the group call.

As another example, a QR code enabling conference members to merely listen to the audio broadcast by the conference public address system during a conference question and answer session may be given to all conference attendees, while a second QR code enabling a conference attendee to ask a question and have the question broadcast by the conference public address system may be provided only to a select set of conference attendees. As a further example, a first QR code enabling a device scanning it to join a network with full permissions may be given to trusted users, while a second QR code enabling a device scanning it to join a network with a reduced set of guest permissions may be give to other un-trusted users.

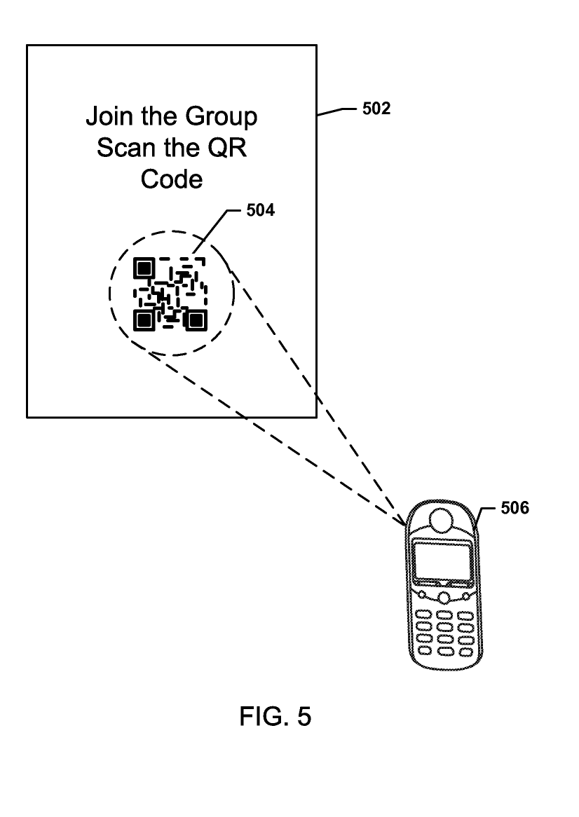

FIG. 5 illustrates an example of a communication device 506 scanning a QR code 504 according to the various embodiments. As an example, the QR code 504 may be displayed on a poster 502. The user of a communication device 506 may use a camera of the communication device 506 to scan (i.e., image) the QR code 504, thereby receiving the QR code 504 at the communication device 506 and making the information embedded in the QR code 504 available to the processor of the communication device 506.

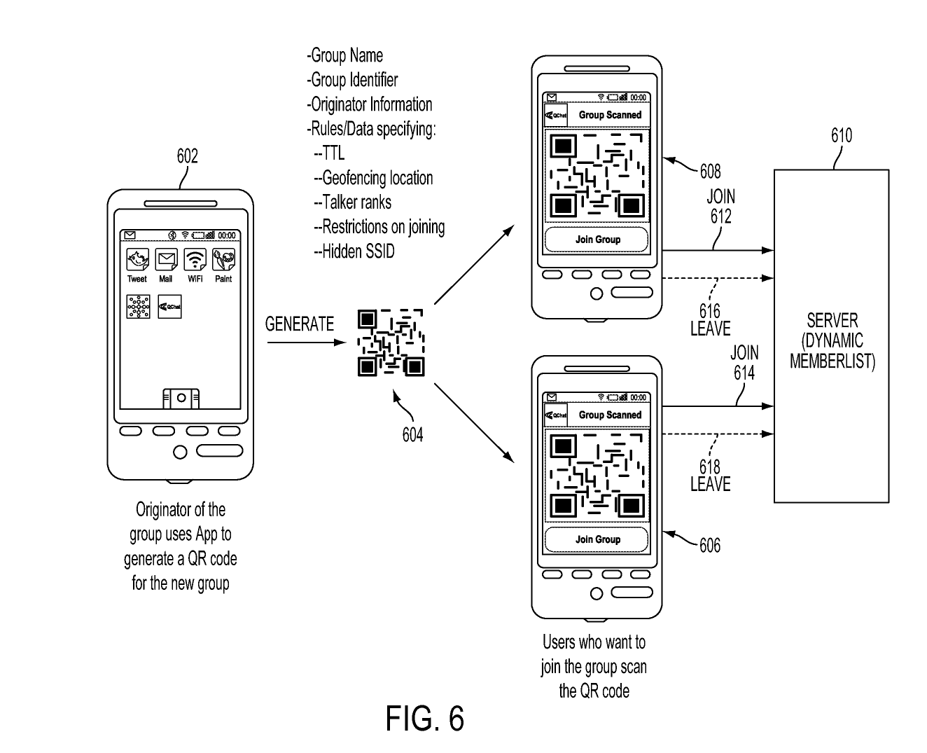

FIG. 6 illustrates example operations performed by a group of communication devices 602, 606, and 608 to originate a group communication independent of a group communication server 610. As an example, the first communication device 602 may generate a QR code 604 including embedded group communication information, such as a group name, group identifier, originator information (e.g., communication device ID, user name/phone number, etc.), and/or group communication controls, such as TTL information, geofencing information, talker ranks, joining restrictions, a hidden SSID, etc. In an embodiment, the group communication information encoded within the QR code 604 may be generated by the first communication device 602 independent of the group communication server 610. In this manner, the group communication information necessary to establish a group communication may be generated by the originating communication device 602 without interactions with the group communication server 610 and/or registering group communication information with the group communication server 610 in advance of generating the QR code 604. The second communication device 606 and the third communication device 608 may each scan the QR code 604 to obtain its encoded information. The second communication device 606 may use the group communication information embedded within the QR code 604 to generate and send a join request message 614 to a group communication server 610. In an embodiment, the join request message 614 may include at least a portion of the group communication information embedded in the QR code 604 scanned by the second communication device 606. As discussed further below, the group communication server 610 may receive the join request message and create the group communication and/or add the second communication device 606 to the group communication. In an embodiment, the join request message from the second communication device 606 may be the first indication to the group communication server 610 that a new group has been defined, and in response the group communication server 610 may establish the group communication according to the information in the join request message which may correspond to the information in the QR code 604. The third communication device 608 may also use the group communication information embedded within the QR code 604 to generate and send a join request message 612 to the group communication server 610, in response to which the group communication server 610 may add the third communication device 608 to the group communication. In an embodiment, to leave the group communication, the second and/or third communication devices 606, 608 may send leave request messages 618, 616, respectively, to the group communication server 610, and in response the group communication server 610 may remove the communication devices 606, 608 from the group communication.

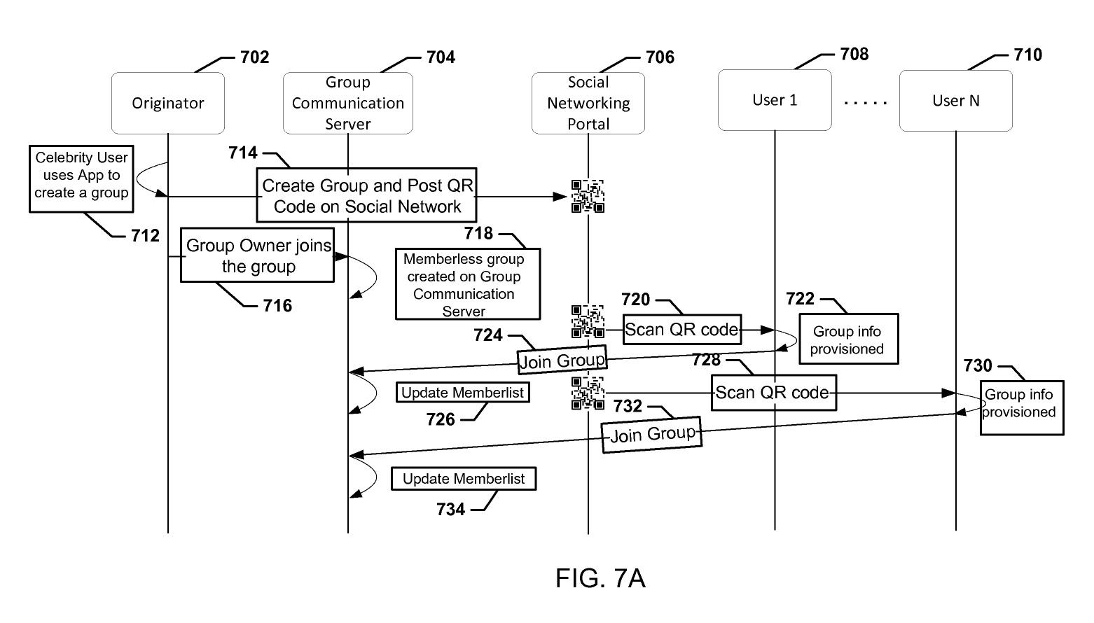

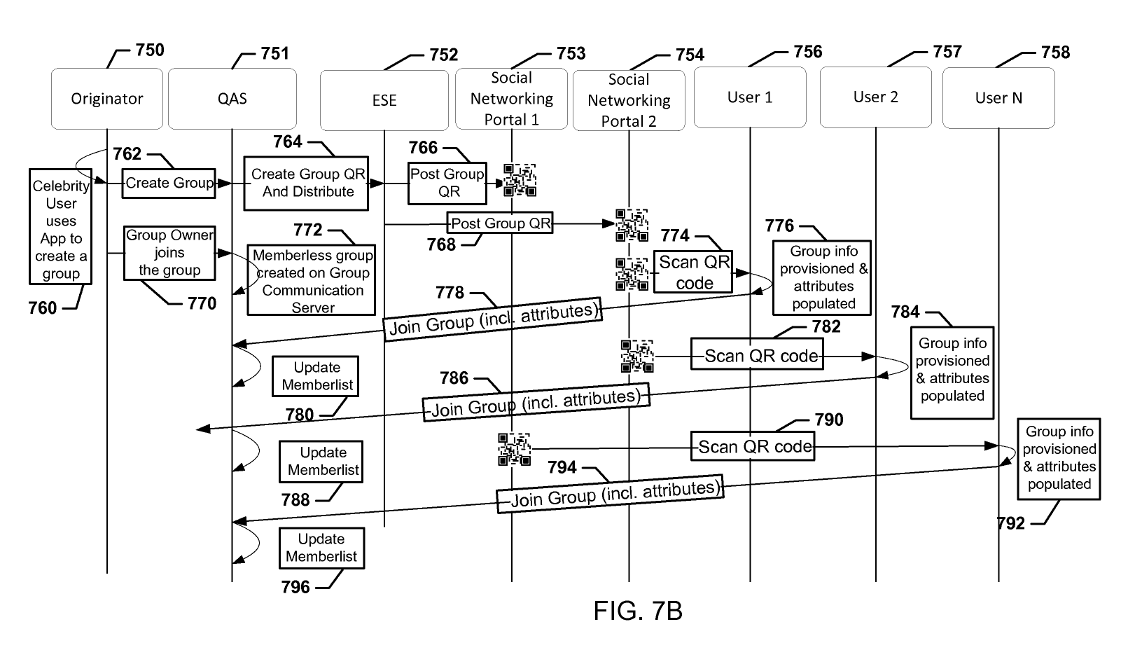

FIG. 7A is a communications flow diagram illustrating example interactions between a group originator device 702, such as a communication device belonging to a celebrity desiring to establish a group communication for an undetermined number of his or her fans, the users of user communication devices 1 708 through N 710. In an embodiment, at an initial time 712 the originator communication device 702 may create a group using a group communication application. As an example, the originator communication device 702 may be the communication device of a celebrity who wishes to create a group call for his or her fans. In an embodiment, the originator communication device 702 may receive group communication controls associated with the group. In block 714 the originator communication device may create a QR code including the group communication controls and post the QR code to a social networking portal 706, such as a Facebook® page. In block 716 the originator communication device 702 may send a join request message to the group communication server 704 and in block 718 the group communication server 704 may establish the group communication and add the originator communication device 702 to the group communication. In an embodiment, the group may be member-less (i.e., no members on group member list except the originator).

In block 720 the user of user communication device 1 708 may scan the QR code from the social networking portal 706. As an example, a fan of the celebrity visiting the celebrity's Facebook® page displaying the QR code may use their communication device to scan the QR code from the Facebook® page. In response to scanning the QR code, in block 722 the group communication information may be provisioned to the user communication device 1 708. In block 724 a join request message may be sent to the group communication server 704 from user communication device 1 708 including the group communication information embedded in the QR code. The group communication server 704 may receive the join request message and in block 726 may add the user communication device 1 708 to the member list. In a similar manner, an unlimited number of users (to user N) may be added to the member list. For example, in block 728 the user of user communication device N 710 may scan the QR code from the social networking portal 706. In response to scanning the QR code, in block 730 the group communication information may be provisioned to the user communication device N 710. In block 732 a join request message may be sent to the group communication server 704 from user communication device N 710 including the group communication information embedded in the QR code. The group communication server 704 may receive the join request message and in block 734 may add the user communication device N 710 to the member list. In the embodiment illustrated in FIG. 7A, the group communication server may require no advanced notice of additional user communication devices to be added to the member list for the group communication, merely providing join request messages with the group communication information from the scanned QR codes may be sufficient for the group communication server 704 to add members to the group communication member list and establish the group communication.

FIG. 7B is a communications flow diagram illustrating example interactions to establish a group communication based on scanning a QR code similar to that illustrated in FIG. 7A, except FIG. 7B illustrates interactions in a specific example using a QChat Application Server (“QAS”) 751 as a group communication server. The QAS 751 may be in communication with an External Server Enabler (“ESE”) 752. In an embodiment, the ESE 752 may be a separate server configured to post information, such as QR codes, to social networking portals 753 and 754. In an alternative embodiment, the ESE 752 may be a component of the QAS 752. FIG. 7B illustrates example interactions between a group originator device 750, such as a communication device belonging to a celebrity desiring to establish a group communication for an undetermined number of fans, a QAS 751, ESE 752, and a plurality of user communication devices, such as user device 1 756, user device 2 757, and user device N 758. In an embodiment, user device 1 756, user device 2 757, and user device N 758 may be configured to conduct different types of group communication sessions. For example, user device 1 756 may be push-to-talk enabled, while user device 2 757 and user device N 758 may be push-to-share enabled.

In an embodiment, at an initial time 760 the originator communication device 750 may create a group using a group communication application. In an embodiment, the originator communication device 750 may receive group communication controls associated with the group. In block 762 the originator communication device may create the group and notify the QAS 751 that the group is created. In block 764 the QAS 764 may create the group QR code and distribute the group QR code to the ESE 752. In an embodiment, the group QR code may include an attribute request, which may indicate to communication devices scanning the QR code that device attributes and/or user information, such as username, phone number, device ID, location, hash code, carrier ID, etc., should be included in join requests generated in response to scanning the group QR code. In block 766 the ESE 752 may post the group QR code to social networking portal 1 753, such as Twitter®, and in block 768 the ESE 752 may post the group QR code to social networking portal 2 754, such as a Facebook® page. In an embodiment, the QR code posted to the social networking portal 1 753 may be different from the QR code posted to the social networking portal 2 754. In an alternative embodiment, the QR codes may be the same.

In block 770 the originator communication device 750 may send a join request message to the QAS 751, and in block 772 the QAS 751 may establish the group communication and add the originator communication device 750 to the group communication. In an embodiment, the group may be member-less (i.e., no members on group member list except the originator).

In block 774, the user of user of communication device 1 756 may scan the QR code from the social networking portal 2 754. As an example, a fan of the celebrity visiting the celebrity's Facebook® page displaying the QR code may use their communication device to scan the QR code from the Facebook® page. In response to scanning the QR code, in block 776 the group communication information may be provisioned to the user communication device 1 756. In an embodiment in which the QR code includes an attribute request, in block 776 the user communication device 1 756 may also populate a join request message with the requested attributes, such as username, phone number, device ID, location, hash code, carrier ID, etc. In block 778 a join request message may be sent to the QAS 751 from the user communication device 1 756 including the group communication information embedded in the QR code and any requested attributes. The QAS 751 may receive the join request message and in block 780 may add the user communication device 1 756 to the member list.

In a similar manner, in block 782 the user of user communication device 2 757 may scan the QR code from the social networking portal 2 754. In response to scanning the QR code, in block 784 the group communication information may be provisioned to the user communication device 2 757. In an embodiment in which the QR code includes an attribute request, in block 784 the user communication device 2 757 may also populate a join request message with the requested attributes, such as username, phone number, device ID, location, hash code, carrier ID, etc. In block 786, a join request message may be sent to the QAS 751 from the user communication device 2 757 including the group communication information embedded in the QR code and any requested attributes. The QAS 751 may receive the join request message, and in block 788 may add the user communication device 2 757 to the member list.

In a similar manner, an unlimited number of users N, may be added to the member list by each communication device scanning the QR code from the social networking portal 1 753 and/or social networking portal 2 754. For example, in block 790 the user of user communication device N 758 may scan the QR code from the social networking portal 1 753. In response to scanning the QR code, in block 792 the group communication information may be provisioned to the user communication device N 758. In an embodiment in which the QR code includes an attribute request, in block 792 the user communication device B 758 may also populate a join request message with the requested attributes, such as username, phone number, device ID, location, hash code, carrier ID, etc. In block 794 a join request message may be sent to the QAS 751 from user communication device N 758 including the group communication information embedded in the QR code and any requested attributes. The QAS 751 may receive the join request message, and in block 796, may add the user communication device N 758 to the member list. In the embodiment illustrated in FIG. 7B, the QAS 751 may require no advanced notice of additional user communication devices to be added to the member list for the group communication, merely receiving join request messages with the group communication information from the scanned QR codes along with any requested attributes may be sufficient for the QAS 751 to add members to the group communication member list and establish the group communication.

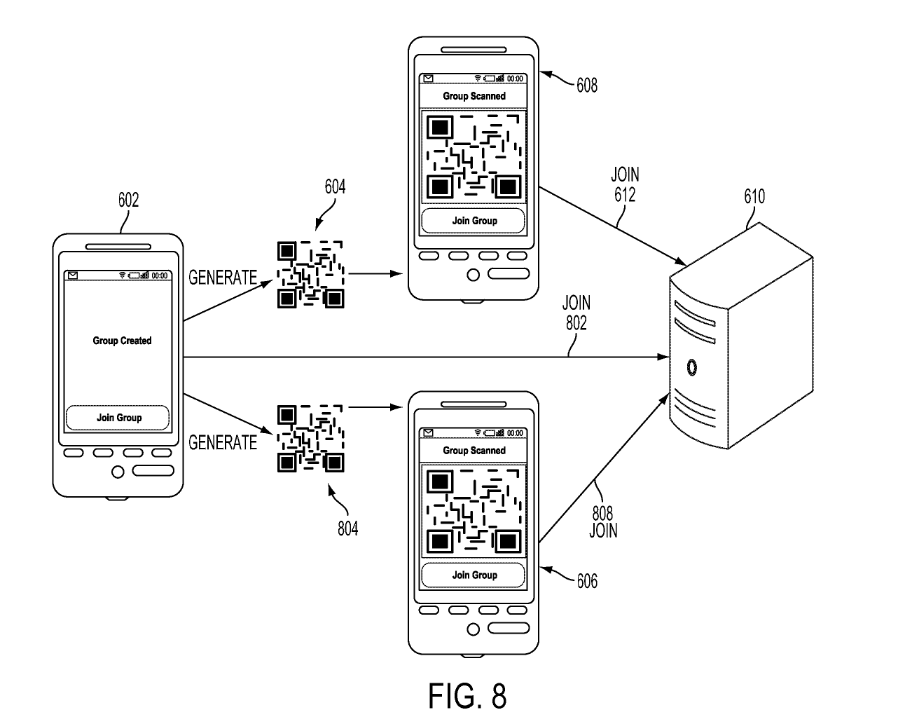

FIG. 8 illustrates example operations that may be performed by a group of communication devices 602, 606, and 608 to originate a group communication independent of a group communication server 610 similar to the operations described above with reference to FIG. 6, except that in FIG. 8 two different QR codes 604 and 704 may be generated by the originating communication device 602. In an embodiment, the first QR code 604 may include different embedded group communication information (e.g., different group communication controls) than embedded within the second code QR code 804. After generating the QR codes 604 and 804, the originator communication device 602 may send a join request message to the group communication server. In an embodiment, the join request message may be different than the join request messages 612 and 808 sent by the communication devices 606 and 608 and may be sent at the same time, before, and/or after the join request messages 612 and 808. Communication device 606 may scan the QR code 804 and send a join request message 808 to the group communication server 610 including information embedded in the QR code 804. Communication device 608 may scan the QR code 604 and send a join request message 612 to the group communication server 610 including information embedded in the QR code 604. In an embodiment in which the QR codes 804 and 604 include different embedded information, such as different group communication controls, the different join request messages 612 and 808 may result in the group communication server 610 establishing different privileges, rules, and/or criteria for communication device 608 and communication device 808 in the group communication.

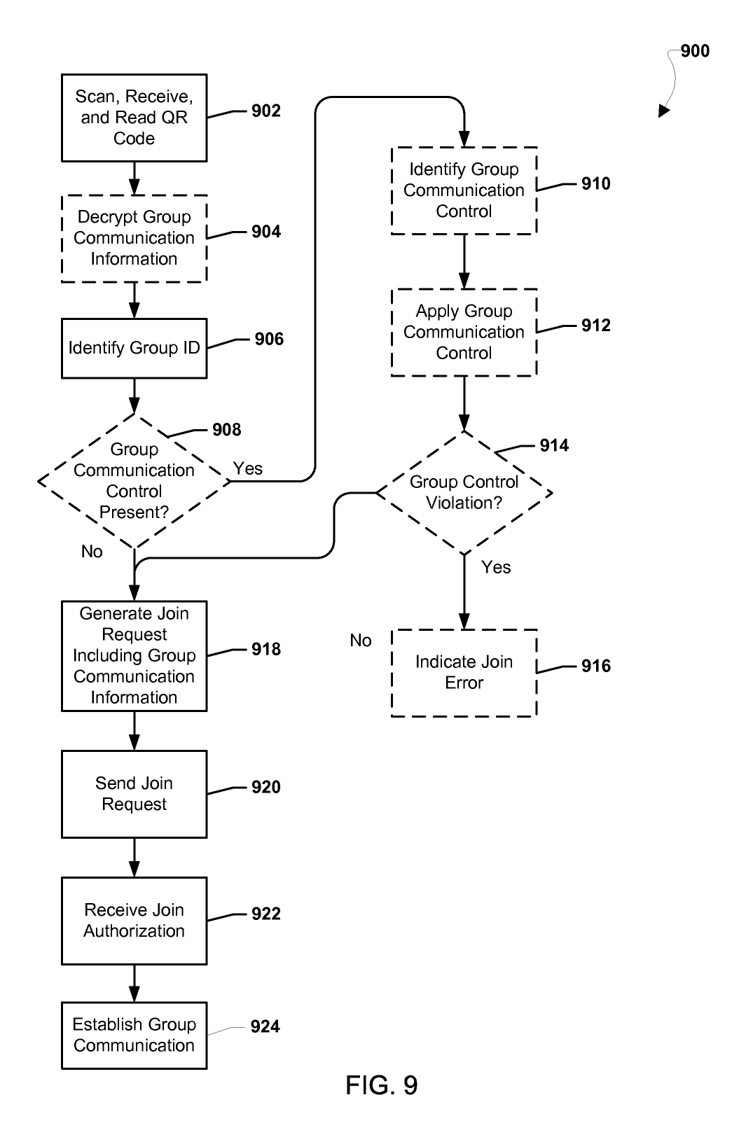

FIG. 9 illustrates an embodiment method 900 for using a QR code to establish a group communication. In an embodiment, the operations of method 900 may be performed by a communication device processor of a communication device that may have scanned a QR code generated according to the various embodiments. In block 902 the communication device processor may scan, receive, and read the QR code. As an example, a QR code may be imaged by a camera of the communication device, the image of the QR code generated by the camera of the communication device may be received by the processor of the communication device, and the processor of the communication device may read the QR code by translating the image of the QR code into group communication information. In an embodiment, reading the QR code may further include applying error correction to the QR code. At optional block 904 the communication device processor may decrypt the group communication information. As an example, the communication device processor may apply a security hash/key provided independent of the QR code to decrypt the group communication information. In block 906 the communication device processor may identify the group ID within the group communication information.

In an optional embodiment, the communication device processor may be configured to determine whether group communication controls are present in the group communication information embedded in the QR code, and apply the group communication controls independent of any interaction with an outside device, such as a group communication server. In this manner, the communication device processor may act as an initial arbiter of join requests and may conserve network resources by not initiating join request messages that may violate the group communication controls. At optional determination block 908 the communication device processor may determine whether a group communication control is present within the group communication information embedded in the QR code. If a group communication control is present (i.e., determination block 908=“Yes”), at optional block 910 the communication device processor may identify the group communication control. As an example, the communication device processor may identify the type (e.g., TTL, list of member IDs, etc.) and rule (e.g., expires July 1, only members on the list of member IDs may join, etc.) in the group control. In block 912 the communication device processor may apply the group communication control, thereby implementing the group communication control on the device. As an example, the communication device processor may set a flag in memory preventing group communications for the group ID after July 1. As another example, the communication device processor may store the list of member IDs in a memory. At optional determination block 914 the communication device processor may determine whether the group communication control is violated. As an example, the communication device processor may determine whether a TTL control has expired for a group ID by comparing the current date to an expiration data in the TTL control, and if the expiration date has passed, may prevent join request messages from being generated for that group ID. As another example, the communication device processor may compare the member ID of a current user to the stored list of member IDs and if the member ID is not present in the stored member list, may prevent join request messages from being generated for that group ID. If the group communication control is violated (i.e., determination block 914=“Yes”), at optional block 916 the communication device processor may indicate a join error. As an example, the communication device processor may indicate a join error with a join error message displayed on a device of the communication device. In a further embodiment, in addition to indicating a join error the communication device may prevent further actions to be taken to establish the group communication.

If the group communication control is not violated (i.e., determination block 914=“No”), if the group communication control is not present (i.e., determination block 908=“No”), and/or the communication device processor is not configured to determine whether a group communication control is present, in block 918 the communication device processor may generate a join request message including at least a portion of the group communication information embedded in the QR code. In block 920 the communication device processor may send the join request message. For example, the communication device processor may send the join request message to a group communication server. In block 922 the communication device processor may receive a join authorization, for example, from a group communication server. In block 924 the communication device processor may establish the group communication, for example via the group communication server with other communication devices.

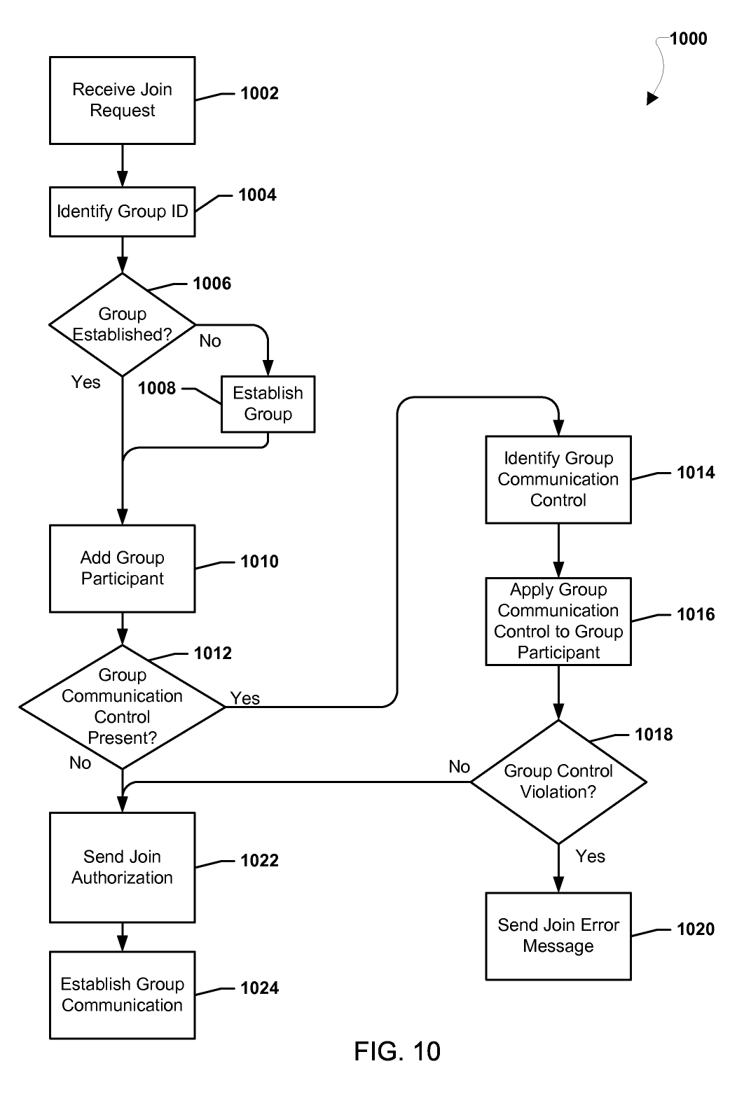

FIG. 10 illustrates an embodiment method 1000 for establishing a group communication. In an embodiment, the operations of method 1000 may be performed by a group communication server. In block 1002 the group communication server may receive a join request message. In an embodiment, a join request message may be a request to join a group communication sent by a communication device including group communication information, such as group communication controls, generated from information embedded in a QR code scanned by the communication device. In block 1004 the group communication server 1004 may identify the group ID based on the group communication information included in the join request message. In determination block 1006 the group communication server may determine whether the group corresponding to the group ID has been previously established. As an example, the group communication server may compare the group ID to a list of established group communications to determine whether the group was previously established. If the group was not previously established (i.e., determination block 1006=“No”), in block 1008 the group communication server may establish the group using the group communication information included in the join request message. In this manner, the group communication server can dynamically establish groups as join request messages are received from communication devices without any pre-provisioning of group communication information and/or network resources prior to an initial join request message.

If the group is established (i.e., determination block 1006=“Yes”), in block 1010 the group communication server may add the group participant associated with the join request message (e.g., join request sender) to the participant/member list for the group communication. In determination block 1012 the group communication server may determine whether a group communication control is present within the group communication information received in the join request message. If a group communication control is present (i.e., determination block 1012=“Yes”), in block 1014 the group communication server may identify the group communication control. As an example, the group communication server may identify the type (e.g., TTL) and rule (e.g., expires July 1) in the group control. In block 1016 the group communication server may apply the group communication control, thereby implementing the group communication control for the group. As examples, the group communication server may apply a TTL to the group, may apply a geofence to the group, may add group members identified in an authorized participants list to the group, may apply speaker ranks to the participants, etc.

In determination block 1018 the group communication server may determine whether the group communication control is violated. As an example, the group communication server may determine whether a TTL control has expired for a group ID by comparing the current date to an expiration data in the TTL control, and if the expiration date has passed, may prevent join authorization and/or group communication establishment for the group ID. If the group communication control is violated (i.e., determination block 1018=“Yes”), in block 1020 the group communication server may send a join error message. In an embodiment the join error message may be sent to the communication device that sent the join request message. In a further embodiment, the join error message may be sent to the originator of the group and/or all current group members. In a further embodiment, in addition to sensing a join error message the group communication server may prevent the originator of the join request message from joining the group.

If the group communication control is not violated (i.e., determination block 1018=“No”) and/or if the group communication control is not present (i.e., determination block 1012=“No”), in block 1022 the group communication server may send a join authorization to the communication device that sent the join request message. In block 1024 the group communication server may establish the group communication.

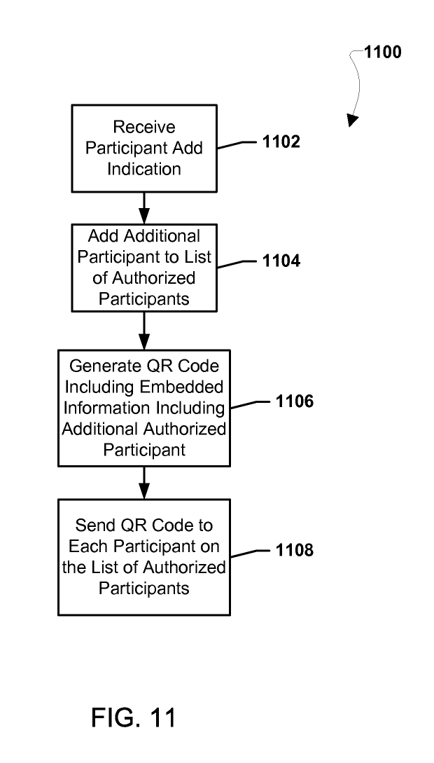

FIG. 11 illustrates an embodiment method 1100 for adding additional participants and generating a new QR code. In an embodiment, the operations of method 1100 may be performed by the communication device processor of a user who desires to add a participant to a group communication. In another embodiment, the operations of method 1100 may be performed by a group communication server. In block 1102 the communication device processor and/or group communication server may receive a participant add indication. As an example, a participant add indication may be a user input to the communication device indicating a participant to add to the group communication and/or may be a message sent to the group communication server requesting an additional participant be added. In block 1104 the communication device processor and/or group communication server may add the additional participant to the list of authorized participants.

In an embodiment, the list of authorized participants may be a group communication control included in a QR code. As such, when the list of authorized participants changes, the QR code for the group communication may require updating. In such an embodiment, in block 1106 the communication device processor and/or group communication server may generate a new QR code including embedded information including the additional authorized participant. In block 1108 the communication device processor and/or group communication server may send the QR code to each participant on the list of authorized participants. In this manner, each participant may receive a QR code with the most up to date group communication information. In an embodiment, in which the group communication information in a join request message must match the group communication information available to a group communication server, a change to an authorized participant list may invalidate QR codes generated prior to the change. The generating and sending of new QR codes following group communication control changes, such as changed authorized participant lists, may prevent authorized participants from being excluded from the group communication because their QR code may be out of date.

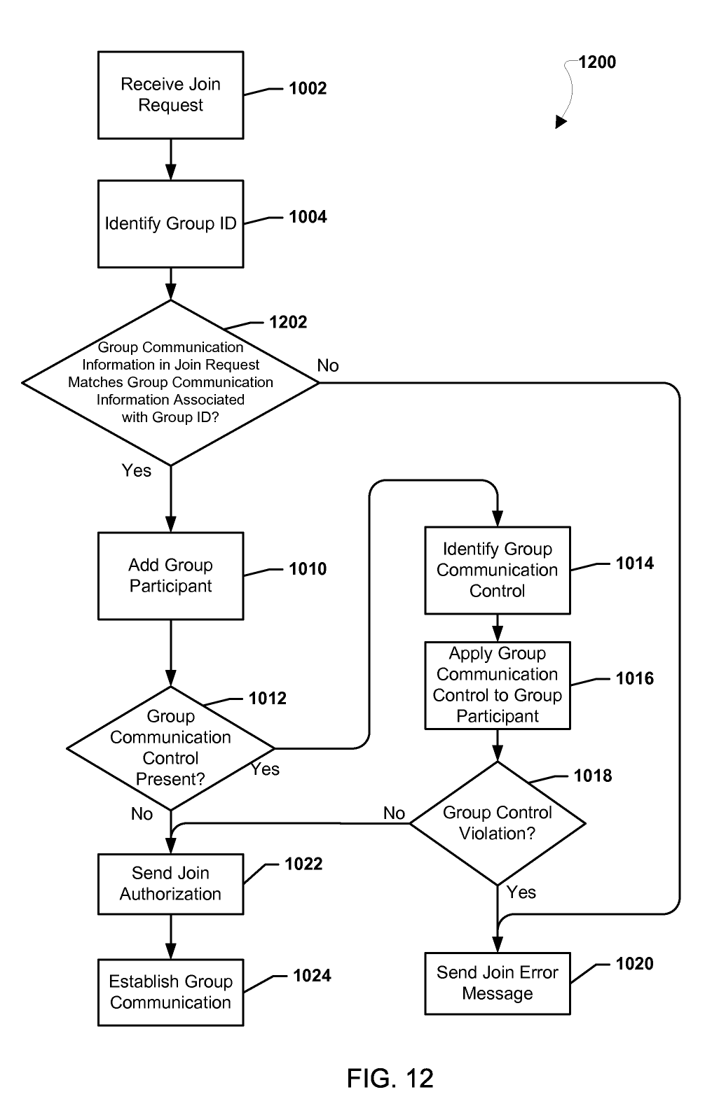

FIG. 12 illustrates an embodiment method 1200 for establishing a group communication similar to method 1000 described with reference to FIG. 10, except that group communication information in a join request message must match group communication information associated with a group ID before a participant may be added to the group communication. As discussed above, in block 1002 the group communication server may receive a join request message, and in block 1004 the group communication server may identify the group ID. In determination block 1202 the group communication server may determine whether the group communication information in the join request message matches the group communication information associated with the group ID. As an example, the group communication information may include a list of authorized participants, and the group communication server may compare the list of authorized participants in the join request message to the list of authorized participants in a memory available to the group communication server to determine whether the lists are the same. If the group communication information in the join request message does not match the group communication information for the group ID (i.e., determination block 1202=“No”), in block 1020 the group communication server may send a join error message as discussed above. If the group communication information in the join request message matches the group communication information for the group ID (i.e., determination block 1202=“Yes”), the group communication server may perform the operations of like numbered blocks 1010, 1012, 1014, 1016, 1018, 1020, 1022, and 1024 discussed above with reference to FIG. 10.

FIG. 13 is a data structure diagram illustrating potential data elements of a QR code 1302. In an embodiment, a QR code 1302 may include a group name 1304, a group ID 1306, and originator information 1320. In an embodiment, a QR code 1302 may include various group communication controls, such as a time to live control 1308, member rank 1310, list of authorized participants 1312, joining restriction 1314, security code 1316, floor control mode 1318, geofence 1322, billing information 1324, attribute request 1326, connection information 1328, and session information 1330. As an example, a time to live control may be an indication that the group may automatically terminate after the expiration of the time to live. As an example, a member rank 1310 may be a priority for a group member over other group members relating to transmitting data, such as audio for that group member. As an example, when a group member with a higher talker rank 1310 speaks, group members with lower talker ranks may be placed on mute.

In an embodiment, a list of group members and their assigned member ranks may be included in a member rank 1310 group communication control. In another embodiment, a rule for assigning member ranks randomly may be included in the member rank 1310 group communication control.

In a further embodiment, a rule for assigning talker ranks based on location and/or domain may be included in the member rank 1310 group communication control. As an example, a list of authorized participants 1312 may be a finite list of group members that are authorized to join the group communication. In this manner, a closed group may be created with a QR code 1302.

Conversely, a QR code 1302 without a finite list of group members may be used to create open groups. As an example, a joining restriction may be a restriction for joining the group, such as minimum device capabilities, location, etc. As an example, a security code 1316 may be a hash value included in the QR code 1302 to authenticate the QR code 1302. As an example, a floor control mode 1320, such as denying a user permission to talk in a group call, but allowing the user to listen. As an example, being located within or outside a geofence 1322 may be a criterion for participation and/or removal from a group.

The originator of a group may specify a location, such as a Global Positioning System (“GPS”) coordinate and a radius from the GPS coordinate. Based on the location of the communication device, such as its GPS coordinates, communication devices outside the radius of the geofence may be prevented from joining the group communication or may be dropped from the group communication. As an example, billing information 1324 may include charging rules and/or charging codes. The originator of a group may specify billing/costs associated with joining the group communication, such as messaging rates, connection charges, etc. The billing information 1324 may also include information related to what the QR code 1302 enables, such as a number of floor control/talk spurt attempts. In this manner, billing information 1324 may provide an indication of the costs of the communication and what a user may be paying for by using the QR code 1302 to join a group communication. As an example, an attribute request 1326 may be an indication of information a joining device must include in any join request message sent to the group communication server. As examples, information requested may include username, phone number, device ID, location, hash code, carrier ID, etc. A device scanning the QR code 1302 including the attribute request 1326 may identify the required information and may include the required information in a generated join request message.

As an example, connection information 1328 may be information directing the communication device scanning the QR code 1302 to use a specific connection to join the group communication session. The connection information 1328 embedded in the QR code 1302 may include network information. Examples of network information that may be embedded in the QR code 1302 include the SSID of a specific Wi-Fi® network to use for the group communication (e.g., a hidden SSID listed in the QR code but not broadcast by routers of the network), and a Uniform Resource Locator (“URL”) of a server hosting connection set-up information for the group communication session. In this manner, a communication device may scan the QR code 1302 and receive connection information 1328 enabling the communication device to join the group communication session using a connection dedicated to the group communication session. As another example, session information 1330 may include the host server name for the group communication session, URL/URI of the server, vocoders to be used for the group communication session, etc.

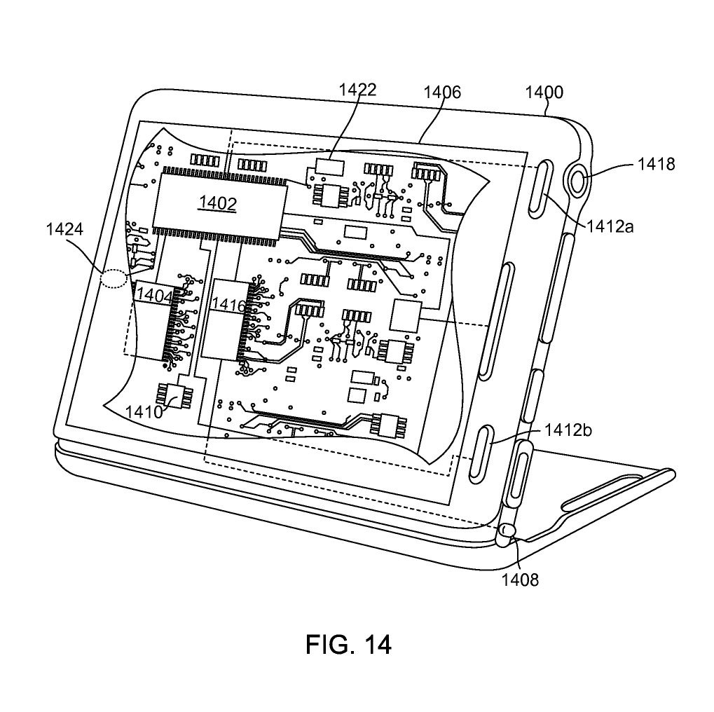

The various embodiments may be implemented in any of a variety of wireless devices, an example of which is illustrated in FIG. 14. For example, the wireless device 1400 may include a processor 1402 coupled to internal memories 1404 and 1410. Internal memories 1404 and 1410 may be volatile or nonvolatile memories, and may also be secure and/or encrypted memories, or unsecure and/or unencrypted memories, or any combination thereof. The processor 1402 may also be coupled to a touch screen display 1406, such as a resistive-sensing touch screen, capacitive-sensing touch screen infrared sensing touch screen, or the like. Additionally, the display of the wireless device 1400 need not have touch screen capability. Additionally, the wireless device 1400 may have one or more antenna 1408 for sending and receiving electromagnetic radiation that may be connected to one or more a wireless data link and/or cellular telephone transceiver 1416 coupled to the processor 1402. The wireless device 1400 may also include physical buttons 1412a and 1412b for receiving user inputs. The wireless device 1400 may also include a power button 1418 for turning the wireless device 1400 on and off. The wireless device 1400 may also include a position sensor 1422, such as a GPS receiver, coupled to the processor 1402. The wireless device 1400 may also include a camera 1424 coupled to the processor 1402.

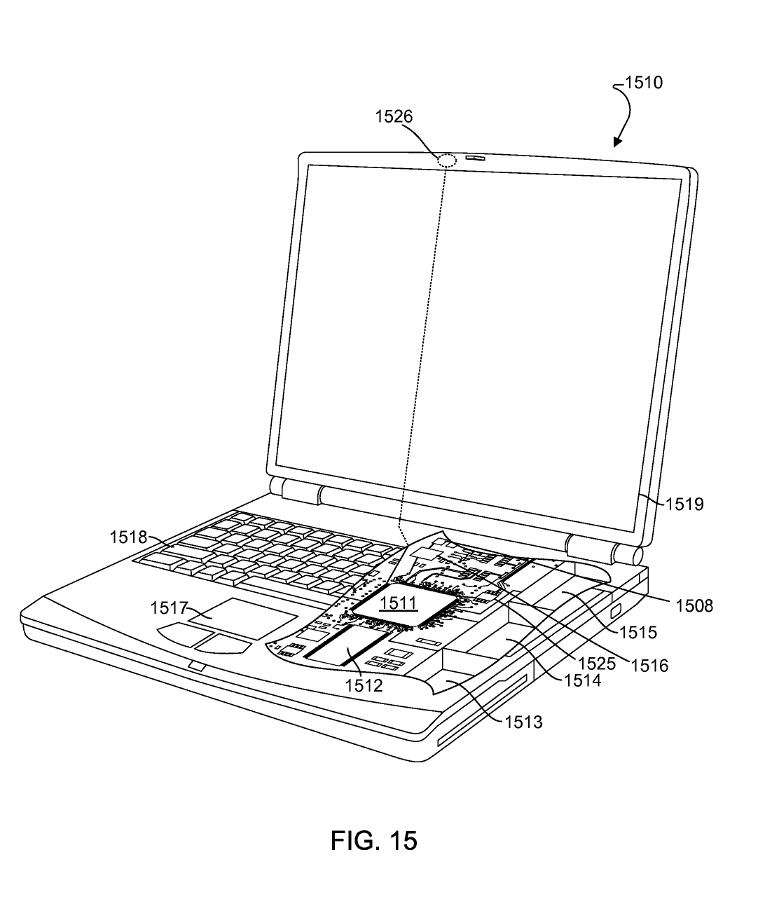

The various embodiments described above may also be implemented within a variety of personal computing devices, such as a laptop computer 1510 as illustrated in FIG. 15. Many laptop computers include a touch pad touch surface 1517 that serves as the computer's pointing device, and thus may receive drag, scroll, and flick gestures similar to those implemented on mobile computing devices equipped with a touch screen display and described above. A laptop computer 1510 will typically include a processor 1511 coupled to volatile memory 1512 and a large capacity nonvolatile memory, such as a disk drive 1513 of Flash memory. The laptop computer 1510 may also include a floppy disc drive 1514 and a compact disc (CD) drive 1515 coupled to the processor 1511. The laptop computer 1510 may also include a number of connector ports coupled to the processor 1511 for establishing data connections or receiving external memory devices, such as a USB or FireWire® connector sockets, or other network connection circuits for coupling the processor 1511 to a network. In a notebook configuration, the computer housing includes the touchpad 1517, the keyboard 1518, and the display 1519 all coupled to the processor 1511. The laptop computer 1510 may also include a position sensor 1525, such as a GPS receiver, coupled to the processor 1511. Additionally, the laptop computer 1510 may have one or more antenna 1508 for sending and receiving electromagnetic radiation that may be connected to one or more a wireless data link and/or cellular telephone transceiver 1516 coupled to the processor 1511. The laptop computer 1510 may also include a camera 1526 coupled to the processor 1511. Other configurations of the computing device may include a computer mouse or trackball coupled to the processor (e.g., via a USB input) as are well known, which may also be used in conjunction with the various embodiments.

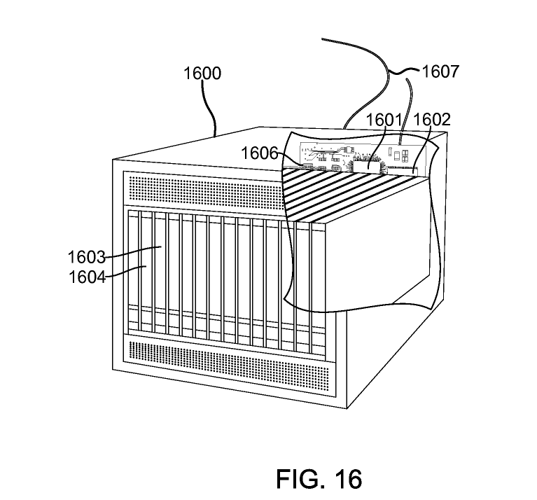

The various embodiments may also be implemented on any of a variety of commercially available server devices, such as the server 1600 illustrated in FIG. 16. Such a server 1600 typically includes a processor 1601 coupled to volatile memory 1602 and a large capacity nonvolatile memory, such as a disk drive 1603. The server 1600 may also include a floppy disc drive, compact disc (CD) or DVD disc drive 1604 coupled to the processor 1601. The server 1600 may also include network access ports 1606 coupled to the processor 1601 for establishing network interface connections with a network 1607, such as a local area network coupled to other broadcast system computers and servers, the Internet, the public switched telephone network, and/or a cellular data network (e.g., CDMA, TDMA, GSM, PCS, 3G, 4G, LTE, or any other type of cellular data network).

The processors 1402, 1511, and 1601 may be any programmable microprocessor, microcomputer or multiple processor chip or chips that can be configured by software instructions (applications) to perform a variety of functions, including the functions of the various embodiments described above. In some devices, multiple processors may be provided, such as one processor dedicated to wireless communication functions and one processor dedicated to running other applications. Typically, software applications may be stored in the internal memory 1404, 1410, 1512, 1513, 1602, and 1603 before they are accessed and loaded into the processors 1402, 1511, and 1601. The processors 1402, 1511, and 1601 may include internal memory sufficient to store the application software instructions. In many devices the internal memory may be a volatile or nonvolatile memory, such as flash memory, or a mixture of both. For the purposes of this description, a general reference to memory refers to memory accessible by the processors 1402, 1511, and 1601 including internal memory or removable memory plugged into the device and memory within the processor 1402, 1511, and 1601 themselves.

The foregoing method descriptions and the process flow diagrams are provided merely as illustrative examples and are not intended to require or imply that the steps of the various embodiments must be performed in the order presented. As will be appreciated by one of skill in the art the order of steps in the foregoing embodiments may be performed in any order. Words such as “thereafter,” “then,” “next,” etc. are not intended to limit the order of the steps; these words are simply used to guide the reader through the description of the methods. Further, any reference to claim elements in the singular, for example, using the articles “a,” “an” or “the” is not to be construed as limiting the element to the singular.

The various illustrative logical blocks, modules, circuits, and algorithm steps described in connection with the embodiments disclosed herein may be implemented as electronic hardware, computer software, or combinations of both. To clearly illustrate this interchangeability of hardware and software, various illustrative components, blocks, modules, circuits, and steps have been described above generally in terms of their functionality. Whether such functionality is implemented as hardware or software depends upon the particular application and design constraints imposed on the overall system. Skilled artisans may implement the described functionality in varying ways for each particular application, but such implementation decisions should not be interpreted as causing a departure from the scope of the present invention.

The hardware used to implement the various illustrative logics, logical blocks, modules, and circuits described in connection with the aspects disclosed herein may be implemented or performed with a general purpose processor, a digital signal processor (DSP), an application specific integrated circuit (ASIC), a field programmable gate array (FPGA) or other programmable logic device, discrete gate or transistor logic, discrete hardware components, or any combination thereof designed to perform the functions described herein. A general-purpose processor may be a microprocessor, but, in the alternative, the processor may be any conventional processor, controller, microcontroller, or state machine. A processor may also be implemented as a combination of computing devices, e.g., a combination of a DSP and a microprocessor, a plurality of microprocessors, one or more microprocessors in conjunction with a DSP core, or any other such configuration. Alternatively, some steps or methods may be performed by circuitry that is specific to a given function.

In one or more exemplary aspects, the functions described may be implemented in hardware, software, firmware, or any combination thereof. If implemented in software, the functions may be stored as one or more instructions or code on a non-transitory computer-readable medium, non-transitory processor-readable medium, or non-transitory server-readable medium. The steps of a method or algorithm disclosed herein may be embodied in a processor-executable software module which may reside on a non-transitory computer-readable, non-transitory processor-readable storage medium, or non-transitory server-readable medium. Non-transitory server-readable, computer-readable or processor-readable storage media may be any storage media that may be accessed by a computer or a processor. By way of example but not limitation, such non-transitory server-readable, computer-readable or processor-readable media may include RAM, ROM, EEPROM, FLASH memory, CD-ROM or other optical disk storage, magnetic disk storage or other magnetic storage devices, or any other medium that may be used to store desired program code in the form of instructions or data structures and that may be accessed by a computer. Disk and disc, as used herein, includes compact disc (CD), laser disc, optical disc, digital versatile disc (DVD), floppy disk, and blu-ray disc where disks usually reproduce data magnetically, while discs reproduce data optically with lasers. Combinations of the above are also included within the scope of non-transitory server-readable, computer-readable and processor-readable media. Additionally, the operations of a method or algorithm may reside as one or any combination or set of codes and/or instructions on a non-transitory server-readable, processor-readable medium and/or computer-readable medium, which may be incorporated into a computer program product.

The preceding description of the disclosed embodiments is provided to enable any person skilled in the art to make or use the present invention. Various modifications to these embodiments will be readily apparent to those skilled in the art, and the generic principles defined herein may be applied to other embodiments without departing from the spirit or scope of the invention. Thus, the present invention is not intended to be limited to the embodiments shown herein but is to be accorded the widest scope consistent with the following claims and the principles and novel features disclosed herein.

What is claimed is:

1. A method of joining a group communication, comprising:
scanning, with a mobile computing device, a Quick Response Code (“QR code”) including embedded group communication information necessary to establish or join a group communication via a group management server, wherein the embedded group communication information includes a group communication control;
sending at least a portion of the embedded group communication information including the group communication control from the mobile computing device to the group management server; and
joining the mobile computing device to the group communication using at least a portion of the group communication information embedded in the QR code.

2. The method of claim 1, wherein the group communication control includes one or more of a time-to-live (“TTL”) control, geofencing control, member rank, a hidden service set identifier, joining restriction, security code, floor control mode, billing information, and a list of authorized participants for the group communication.

3. The method of claim 1, wherein the QR code includes an attribute request, the method further comprising:
sending attribute information for an attribute identified in the attribute request to the group management server.

4. A method for dynamic self provisioning of a group communication, comprising:
generating a Quick Response Code (“QR code”) including embedded group communication information necessary to establish or join a group communication via a group management server, wherein the embedded group communication information includes a group communication control; and
presenting the QR code so that it may be scanned by mobile computing devices to join the group communication.

5. The method of claim 4, wherein the group communication control includes a list of authorized participants for the group communication, the method further comprising:
adding an additional authorized participant to the list of authorized participants for the group communication;
generating a new QR code including the embedded group communication information including the additional authorized participant; and
sending the new QR code to each user on the list of authorized participants for the group communication.

6. The method of claim 4, wherein the embedded group communication information further includes an attribute request.

7. The method of claim 4, wherein the group communication control includes one or more of a time-to-live (“TTL”) control, geofencing control, member rank, hidden service set identifier, joining restriction, security code, floor control mode, and billing information.

8. A method of establishing a group communication, comprising:
receiving, in a server, group communication information including a group communication control from a first mobile computing device, wherein the group communication information was embedded within a Quick Response Code (“QR code”);
establishing a group communication based on the received group communication information;
joining the first mobile computing device to the group communication;
receiving a join request message from a second mobile computing device, wherein the join request message includes information from the QR code; and
joining the second mobile computing device to the group communication based on information within the join request message.

9. A mobile computing device, comprising:
means for scanning a Quick Response Code (“QR code”) including embedded group communication information necessary to establish or join a group communication via a group management server, wherein the embedded group communication information includes a group communication control;
means for sending at least a portion of the embedded group communication information including the group communication control to the group management server; and
means for receiving a join authorization from the group management server in response to the group management server joining the mobile computing device to the group communication using at least a portion of the group communication information embedded in the QR code.

10. The mobile computing device of claim 9, wherein the group communication control includes one or more of a time-to-live (“TTL”) control, geofencing control, member rank, hidden service set identifier, joining restriction, security code, floor control mode, billing information, and a list of authorized participants for the group communication.

11. The mobile computing device of claim 9, wherein the QR code includes an attribute request, the mobile computing device further comprising means for sending attribute information for an attribute identified in the attribute request to the group management server.

12. A device, comprising:
means for generating a Quick Response Code (“QR code”) including embedded group communication information necessary to establish or join a group communication via a group management server, wherein the embedded group communication information includes a group communication control; and
means for presenting the QR code so that it may be scanned by mobile computing devices to join the group communication.

13. The device of claim 12, wherein the group communication control includes a list of authorized participants for the group communication, the device further comprising:
means for adding an additional authorized participant to the list of authorized participants for the group communication;
means for generating a new QR code including the embedded group communication information including the additional authorized participant; and
means for sending the new QR code to each user on the list of authorized participants for the group communication.

14. The device of claim 12, wherein the embedded group communication information further includes an attribute request.

15. The device of claim 12, wherein the group communication control includes one or more of a time-to-live (“TTL”) control, geofencing control, member rank, hidden service set identifier, joining restriction, security code, floor control mode, and billing information.

16. A server, comprising:
means for receiving group communication information including a group communication control from a first mobile computing device, wherein the group communication information was embedded within a Quick Response Code (“QR code”);
means for establishing a group communication based on the received group communication information;
means for joining the first mobile computing device to the group communication;
means for receiving a join request message from a second mobile computing device, wherein the join request message includes information from the QR code; and
means for joining the second mobile computing device to the group communication based on information within the join request message.

17. A mobile computing device, comprising:
a transceiver configured to communicate with a network;
a camera; and
a processor connected to the transceiver and camera, wherein the processor is configured with processor-executable instructions to perform operations comprising:
scanning, with the camera, a Quick Response Code (“QR code”) including embedded group communication information necessary to establish or join a group communication via a group management server, wherein the embedded group communication information includes a group communication control;
sending at least a portion of the embedded group communication information including the group communication control to the group management server via the transceiver; and
receiving, via the transceiver, a join authorization from the group management server in response to the group management server joining the mobile computing device to the group communication using at least a portion of the group communication information embedded in the QR code.

18. The mobile computing device of claim 17, wherein the group communication control includes one or more of a time-to-live (“TTL”) control, geofencing control, member rank, hidden service set identifier, joining restriction, security code, floor control mode, billing information, and a list of authorized participants for the group communication.

19. The mobile computing device of claim 17, wherein:
the QR code includes an attribute request; and
the processor is configured with processor-executable instructions to perform operations further comprising sending attribute information for an attribute identified in the attribute request to the group management server via the transceiver.

20. A device, comprising:
a transceiver configured to communicate with a network; and
a processor connected to the transceiver, wherein the processor is configured with processor-executable instructions to perform operations comprising:
generating a Quick Response Code (“QR code”) including embedded group communication information necessary to establish or join a group communication via a group management server, wherein the embedded group communication information includes a group communication control; and
presenting the QR code so that it may be scanned by mobile computing devices to join the group communication.

21. The device of claim 20, wherein:
the processor is configured with processor-executable instructions to perform operations such that the group communication control includes a list of authorized participants for the group communication; and
the processor is configured with processor-executable instructions to perform operations further comprising:
adding an additional authorized participant to the list of authorized participants for the group communication;
generating a new QR code including the embedded group communication information including the additional authorized participant; and
sending the new QR code to each user on the list of authorized participants for the group communication via the transceiver.

22. The device of claim 20, wherein the embedded group communication information further includes an attribute request.

23. The device of claim 20, wherein the group communication control includes one or more of a time-to-live (“TTL”) control, geofencing control, member rank, hidden service set identifier, joining restriction, security code, floor control mode, and billing information.

24. A server, comprising:
a transceiver configured to communicate with a network;
a processor connected to the transceiver, wherein the processor is configured with processor-executable instructions to perform operations comprising:
receiving group communication information including a group communication control from a first mobile computing device via the transceiver, wherein the group communication information was embedded within a Quick Response Code (“QR code”);
establishing a group communication based on the received group communication information;
joining the first mobile computing device to the group communication;
receiving a join request message from a second mobile computing device via the transceiver, wherein the join request message includes information from the QR code; and
joining the second mobile computing device to the group communication based on information within the join request message.

25. A non-transitory processor readable storage medium having stored thereon processor-executable instructions configured to cause a mobile computing device processor to perform operations comprising:
scanning a Quick Response Code (“QR code”) including embedded group communication information necessary to establish or join a group communication via a group management server, wherein the embedded group communication information includes a group communication control;
sending at least a portion of the embedded group communication information including the group communication control to the group management server; and
receiving a join authorization from the group management server in response to the group management server joining the mobile computing device to the group communication using at least a portion of the group communication information embedded in the QR code.

26. The non-transitory processor readable medium of claim 25, wherein the stored processor-executable instructions are configured to cause a mobile computing device processor to perform operations such that the group communication control includes one or more of a time-to-live (“TTL”) control, geofencing control, member rank, hidden service set identifier, joining restriction, security code, floor control mode, billing information, and a list of authorized participants for the group communication.

27. The non-transitory processor readable medium of claim 25, wherein:
the stored processor-executable instructions are configured to cause a mobile computing device processor to perform operations such that such that the QR code includes an attribute request; and
the stored processor-executable instructions are configured to cause a mobile computing device processor to perform operations further comprising sending attribute information for an attribute identified in the attribute request to the group management server.

28. A non-transitory processor readable storage medium having stored thereon processor-executable instructions configured to cause a processor to perform operations comprising:
generating a Quick Response Code (“QR code”) including embedded group communication information necessary to establish or join a group communication via a group management server, wherein the embedded group communication information includes a group communication control; and
presenting the QR code so that it may be scanned by mobile computing devices to join the group communication.

29. The non-transitory processor readable medium of claim 28, wherein:
the stored processor-executable instructions are configured to cause a processor to perform operations such that the group communication control includes a list of authorized participants for the group communication; and
the stored processor-executable instructions are configured to cause a processor to perform operations further comprising:
adding an additional authorized participant to the list of authorized participants for the group communication;
generating a new QR code including the embedded group communication information including the additional authorized participant; and
sending the new QR code to each user on the list of authorized participants for the group communication.

30. The non-transitory processor readable medium of claim 28, wherein the stored processor-executable instructions are configured to cause a processor to perform operations such that the embedded group communication information further includes an attribute request.

31. The non-transitory processor readable medium of claim 28, wherein the stored processor-executable instructions are configured to cause a processor to perform operations such that the group communication control includes one or more of a time-to-live (“TTL”) control, geofencing control, member rank, hidden service set identifier, joining restriction, security code, floor control mode, and billing information.

32. A non-transitory server-readable storage medium having stored thereon server-executable instructions configured to cause a server to perform operations comprising:
receiving group communication information including a group communication control from a first mobile computing device, wherein the group communication information was embedded within a Quick Response Code (“QR code”);
establishing a group communication based on the received group communication information;
joining the first mobile computing device to the group communication;
receiving a join request message from a second mobile computing device, wherein the join request message includes information from the QR code; and
joining the second mobile computing device to the group communication based on information within the join request message.

33. A system, comprising:
a group management server; and
a mobile computing device, comprising:
means for scanning a Quick Response Code (“QR code”) including embedded group communication information necessary to establish or join a group communication via the group management server, wherein the embedded group communication information includes a group communication control;
means for sending at least a portion of the embedded group communication information including the group communication control to the group management server,
wherein the group management server comprises:
means for receiving the at least a portion of the embedded group communication information including the group communication control; and
means for joining the mobile computing device to the group communication using the received at least a portion of the group communication information embedded in the QR code.

34. The system of claim 33, wherein the group communication control includes one or more of a time-to-live (“TTL”) control, geofencing control, member rank, hidden service set identifier, joining restriction, security code, floor control mode, billing information, and a list of authorized participants for the group communication.

35. The system of claim 33, wherein the QR code includes an attribute request, the mobile computing device further comprising means for sending attribute information for an attribute identified in the attribute request to the group management server.

36. A system comprising, comprising:
mobile computing devices; and
a device comprising:
means for generating a Quick Response Code (“QR code”) including embedded group communication information necessary to establish or join a group communication via a group management server, wherein the embedded group communication information includes a group communication control; and
means for presenting the QR code so that it may be scanned by the mobile computing devices to join the group communication.

37. The system of claim 36, wherein the group communication control includes a list of authorized participants for the group communication, the device further comprising:
means for adding an additional authorized participant to the list of authorized participants for the group communication;
means for generating a new QR code including the embedded group communication information including the additional authorized participant; and
means for sending the new QR code to each user on the list of authorized participants for the group communication.

38. The system of claim 36, wherein the embedded group communication information further includes an attribute request.

39. The system of claim 36, wherein the group communication control includes one or more of a time-to-live (“TTL”) control, geofencing control, member rank, hidden service set identifier, joining restriction, security code, floor control mode, and billing information.

40. A system, comprising:
a server;
a first mobile computing device comprising means for sending group communication information including a group communication control to the server, wherein the group communication information was embedded within a Quick Response Code (“QR code”); and
a second mobile computing device,
wherein:
the server comprises:
means for receiving the group communication information including a group communication control from the first mobile computing device; and
means for establishing a group communication based on the received group communication information;
the second mobile computing device comprises means for sending a join request message to the server, wherein the join request message includes information from the QR code; and
the server further comprises:
means for receiving the join request message from the second mobile computing device; and
means for joining the second mobile computing device to the group communication based on information within the join request message.

41. A system, comprising:
a group management server, comprising:
a server transceiver configured to communicate with a network; and
a server processor connected to the server transceiver; and
a mobile computing device, comprising:
a camera;
a device transceiver configured to communicate with the network; and
a device processor connected to the device transceiver and camera, wherein the device processor is configured with processor-executable instructions to perform operations comprising:
scanning with the camera a Quick Response Code (“QR code”) including embedded group communication information necessary to establish or join a group communication via the group management server, wherein the embedded group communication information includes a group communication control; and
sending at least a portion of the embedded group communication information including the group communication control to the group management server, and
wherein the server processor is configured with processor-executable instructions to perform operations comprising:
receiving the at least a portion of the embedded group communication information including the group communication control; and
joining the mobile computing device to the group communication using the received at least a portion of the group communication information embedded in the QR code.

42. The system of claim 41, wherein the group communication control includes one or more of a time-to-live (“TTL”) control, geofencing control, member rank, hidden service set identifier, joining restriction, security code, floor control mode, billing information, and a list of authorized participants for the group communication.

43. The system of claim 41, wherein the QR code includes an attribute request, and wherein the device processor is configured with processor-executable instructions to perform operations further comprising sending attribute information for an attribute identified in the attribute request to the group management server.

44. A system comprising, comprising:
mobile computing devices each comprising:
a mobile device transceiver configured to communicate with a network; and
a mobile device processor connected to the mobile device transceiver; and
a device, comprising:
a device transceiver configured to communicate with the network; and
a device processor connected to the device transceiver, wherein the device processor is configured with processor-executable instructions to perform operations comprising:
generating a Quick Response Code (“QR code”) including embedded group communication information necessary to establish or join a group communication via a group management server, wherein the embedded group communication information includes a group communication control; and
presenting the QR code so that it may be scanned by the mobile computing devices to join the group communication.

45. The system of claim 44, wherein the group communication control includes a list of authorized participants for the group communication, and wherein the device processor is configured with processor-executable instructions to perform operations further comprising:
adding an additional authorized participant to the list of authorized participants for the group communication;
generating a new QR code including the embedded group communication information including the additional authorized participant; and
sending the new QR code to each user on the list of authorized participants for the group communication via the device transceiver.

46. The system of claim 44, wherein the embedded group communication information further includes an attribute request.

47. The system of claim 44, wherein the group communication control includes one or more of a time-to-live (“TTL”) control, geofencing control, member rank, hidden service set identifier, joining restriction, security code, floor control mode, and billing information.

48. A system, comprising:
a server comprising:
a server transceiver configured to communicate with a network; and
a server processor connected to the server transceiver;
a first mobile computing device comprising:
a first device transceiver configured to communicate with the network; and
a first device processor connected to the first device transceiver, wherein the first device processor is configured with processor-executable instructions to perform operations comprising:
sending group communication information including a group communication control to the server via the first device transceiver, wherein the group communication information was embedded within a Quick Response Code (“QR code”); and
a second mobile computing device comprising:
a second device transceiver configured to communicate with the network; and
a second device processor connected to the second device transceiver,
wherein:
the server processor is configured with processor-executable instructions to perform operations comprising:
receiving the group communication information including a group communication control from the first mobile computing device via the server transceiver; and
establishing a group communication based on the received group communication information;
the second device processor is configured with processor-executable instructions to perform operations comprising sending a join request message to the server via the second device transceiver, wherein the join request message includes information from the QR code; and
the server processor is configured with processor-executable instructions to perform operations further comprising:
receiving the join request message from the second mobile computing device via the server transceiver; and
joining the second mobile computing device to the group communication based on information within the join request message.
